(19) United States
(12) Patent Application Publication
(10) Pub. No.: US 2006/0276174 A1
(43) Pub. Date: Dec. 7, 2006

(54) Method and an apparatus for provisioning content data

(76) Inventors: Eyal Katz, Ramat-Gan (IL); Ofir Paz, Rishon-LeZion (IL)

Correspondence Address: Martin D. MOYNIHAN;PRTSI, Inc., P.O. Box 16446, Arlington, VA, 22215, US

(21) Appl. No.: 11/411,772

(22) Filed: Apr. 27, 2006

Related U.S. Application Data
(60) Provisional application No. 60/742,878, filed on Dec. 7, 2005.
(60) Provisional application No. 60/720,046, filed on Sep. 26, 2005.
(60) Provisional application No. 60/675,926, filed on Apr. 29, 2005.

(51) Int. Cl. H04M 3/16; H04M 1/68

(52) U.S. Cl. 455/410

(57) ABSTRACT

An apparatus for provisioning content in an intuitive-associative manner comprising: a data receiver, for receiving data identifying a transmission source from a user, a matcher, associated with the data receiver, for matching at least one relevant item transmitted in the source at a time frame of the receiving with at least one content item, and a provisioner, associated with the matcher, for provisioning selected content items of the content items to the user.

### RELATED APPLICATIONS

This Application claims the benefit of U.S. Provisional Patent Application No. 60/742,878 filed on Dec. 7, 2005, U.S. Provisional Patent Application No. 60/720,046 filed on Sep. 26, 2005, and U.S. Provisional Patent Application No. 60/675,926 filed on Apr. 29, 2005 the contents of which are hereby incorporated in its entirety.

### FIELD AND BACKGROUND OF THE INVENTION

The present invention relates generally to a content provisioning apparatus and method. More particularly but not exclusively, the present invention relates to apparatus and a method for provisioning content on an impulsive-associative manner.

Sales through cellular networks and the Internet have become a booming market.

Strategy Analytics research groups estimate that by 2008 wireless subscribers will be spending over $11 Billion globally to download applications over cellular networks to mobile devices. Cellular Carriers project significant revenue growth from content delivery as an overall percentage of their wireless data revenues.

Ringtone (monotones and polytones) sales hit 3.2 billion US dollars in 2003 and are expected to reach 8.2 billion US dollars in 2008 (according to The ARC Group).

The total value of global market games is expected to reach a record 5.6 billion US dollars by the end of 2005 (Jupiter research).

According to The Arc Group, the mobile entertainment content business (including games, ringtones, and other content) is expected to hit 27 billion US dollars by the end of 2008.

There are many known in the art methods and systems for provisioning contents over a cellular network or the Internet.

US Patent Application Publication No. 20030232616, entitled “Rule-based system and method for managing the provisioning of user applications on limited-resource and/or wireless devices” addresses various aspects of aggregation and management of contents.

US Patent Application Publication No. 20030154487, entitled “Digital content providing system” provides a technique to perform delivery and billing in a digital content providing system through a network.

However the current processes of purchasing through cellular networks or the Internet are rather cumbersome.

Currently, a user is expected to provide at least one piece of information related to the content he is interested in receiving: a performer's name, a song name, an album name, a ringtone catalog number etc. Typically the user also has to navigate through flexible multiple paged menus, which is a time-consuming and inconvenient user experience.

Furthermore many users are deterred by such a multiple paged menu-driven approach, lack patience for such a cumbersome process, or fail to recall the information related to the content they are interested in (such as the name of a performer or a song just played on the user's favorite radio station).

Reference is now made to FIG. 1 which is a flow chart illustrating an exemplary scenario for acquiring content according to the prior art.

In the exemplary prior art scenario, a user hears a song on the radio or watches a clip on TV 100. The user likes the song or clip and decides he wants to have the song/clip as a ringtone (monotone, polytones. etc.) on his cellular phone 120. The user has to give at least one piece of information specifically related to the ringtone he is interested in downloading: a performer name, a song name, a ringtone catalog number etc. 140, information which the user does not necessarily have and which may simply slip the mind of the user. Typically, for giving the information, the user also has to browse through multiple paged menus so as to provide the information related to the ringtone 160. Having found the ringtone at last 180, the user may now download the ringtone 190.

As illustrated with the above example, prior art does not provide with a truly impulsive-associative content purchasing method as the user must provide information which relates specifically to the content the user is interested in.

The Internet has also induced a booming content market. For example, a user may wish to search the Internet for a video clip he has just watched on MTV, for downloading the video clip to his personal computer (PC). Searching for the clip, the user has to use an Internet search engine such the Google™ search engine where he must also provide at least one piece of information specifically related to the clip he is interested in downloading: a performer name, a song title, an album title etc.

There is thus a widely recognized need for, and it would be highly advantageous to have an apparatus and method for impulsive-associative content provisioning which is devoid of the above limitations.

### SUMMARY OF THE INVENTION

According to one aspect of the present invention there is provided an apparatus for provisioning content in an intuitive-associative manner.

The apparatus may comprise: a data receiver, for receiving data identifying a transmission source from a user, a matcher, associated with the data receiver, for matching at least one relevant item transmitted in the source at a time frame of the receiving with at least one content item, and a provisioner, associated with the matcher, for provisioning selected content items of the content items to the user.

The apparatus may further comprise an extractor, associated with the data receiver, for extracting an identity of the source from the data.

The source may be a broadcasting channel such as a TV station or a radio channel, a narrowcasting channel such an Internet Peer to Peer (P2P) data channel. etc.

Optionally, the matcher is further configured to retrieve the relevant items from a list of items transmitted in the source over the time frame. The list of items may be dynamically assembled for each source by an assembler being a part of the apparatus.

Preferably, the assembler comprises: a source item reader, for reading an item being transmitted in the source, an item identifier, associated with the source item reader, for generating data identifying the transmitted item, and a list updater, associated with the item identifier, for updating the list of items with the data identifying the transmitted item and a respective time frame of transmission of the identified transmitted item.

The assembler may further comprise a statistics generator, configured to dynamically generate statistics relating to items transmitted in the source.

The item identifier may be further configured to use one of a group comprising: statistics relating to items transmitted in the source, general statistics relating to transmitted items, and statistics relating to preferences according to a geographic region of the source.

The apparatus of further comprise a content catalog builder, for building a content catalog, the content catalog builder comprising: an item receiver, for receiving a content item, an identification receiver, for receiving identification data of the content item, a fingerprint extractor, for extracting an identifying fingerprint from the content item, and a content updater, for updating the content catalog with the identifying fingerprint and with the identification data.

The content catalog builder may further include a remote content updater, operable for remotely updating the content catalog with an identifying fingerprint pointing to a remotely stored content item and for remotely updating the content catalog with identification data relating to a remotely stored content item.

The content updater may be further configured to update the content catalog with data pertaining to a location of the fingerprint within the content item.

Preferably, the provisioner is further configured to present the content items to the user in a dynamically configurable interactive graphical user interface (GUI).

The provisioner may be further configured to select at least one of the content items for provisioning to the user, according to at least one of a group comprised of: a predefined preference with respect to the content items, information relating to the user, information relating to content items, provisioning history data, capabilities of a receiving device used by the user, geographic data, demographic data, socio-economical data, and user made selections.

The extractor may be configured to utilize at least one of a group comprised of optical character recognition (OCR), image processing, and spelling correction.

The apparatus may further comprise a history recorder,.associated with the provisioner, configured to record history data relating to content provisioning to the user. The history recorder may be configured to record back-up data pertaining to the provisioned content items, for future use by the user.

The recorded back up data may comprise provisioned content items to be used by the user, say for allowing the user to download content items previously provisioned to him.

The apparatus may also comprise a correlation data generator, associated with the provisioner, configured to generate correlation data pertaining to correlation between transmission of an item in a source and provisioning of a respective content item to a user. The correlation data may comprise at least one of a group comprising: user characterizing data, source data, time of provisioning, type of content item, geographic data, demographic data, and socio-economic data.

According to a second aspect of the present invention there is provided a method for provisioning content in an intuitive-associative manner, comprising: receiving data identifying a transmission source from a user, matching at least one relevant item transmitted in the source at a time frame of the receiving with at least one content item, and provisioning selected content items of the content items to the user. Optionally, the method further comprises extracting an identity of the source from the data.

According to a third aspect of the present invention there is provided an apparatus for provisioning content in an intuitive-associative manner, comprising: a data receiver, for receiving a user message, a provisioner, associated with the data receiver, for provisioning a content item to a user, according to the user message, a matcher, associated with the provisioner, for matching the provisioned content item with a relevant item from at least one item transmitted in a respective source, the matching being carried out according to a time frame of the user message and relevance of the transmitted item to the provisioned content item; and a correlation data generator, associated with the matcher, for generating data pertaining to correlation between the relevant item and the provisioned item.

Optionally, the apparatus is further configured to retrieve the relevant item from a list of items transmitted in the source.

The provisioner may be further configured to facilitate purchase of goods or services, utilizing the selected content items.

The provisioner may be further configured to facilitate betting or gambling, utilizing the selected content items.

The provisioner may be further configured to facilitate multi party games through the internet or the mobile operators, utilizing the selected content items.

According to a fourth aspect of the present invention there is provided an apparatus for assembling a source list of items, comprising: a source item reader, for reading an item being transmitted in the source, an item identifier, associated with the source item reader, for identifying the transmitted item, and a list updater, associated with the item identifier, for updating the source list of items with identification data of the identified transmitted item and a respective time frame of transmission of the identified transmitted item.

The item identifier may be further configured to compare a fingerprint of the read item with at least one identifying fingerprint residing in a content catalog, each of the identifying fingerprints relating to a respective content item. The item identifier may be further configured to use data pertaining to a location of a fingerprint within an item, for carrying out the identifying.

The apparatus may also include a statistics generator, configured to dynamically generate statistics relating to items transmitted in the source.

The apparatus may also include a statistics generator, configured to dynamically generate statistics relating to users and their purchasing preferences.

The item identifier carries out the identifying using one of a group comprising: statistics relating to items transmitted in the source, general statistics relating to transmitted items, statistics relating to preferences according to a geographic region of the source, and user's behavior patterns with relation to purchasing of goods and services.

According to a fifth aspect of the present invention there is provided an apparatus for provisioning content in an intuitive-associative manner, comprising: a data receiver, for receiving data identifying a transmission source from a user, a matcher, associated with the data receiver, for matching at least one relevant item transmitted in the source with at least one content item, and a provisioner, associated with the matcher, for provisioning selected content items of the content items to the user.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart illustrating an exemplary scenario for acquiring content according to prior art;

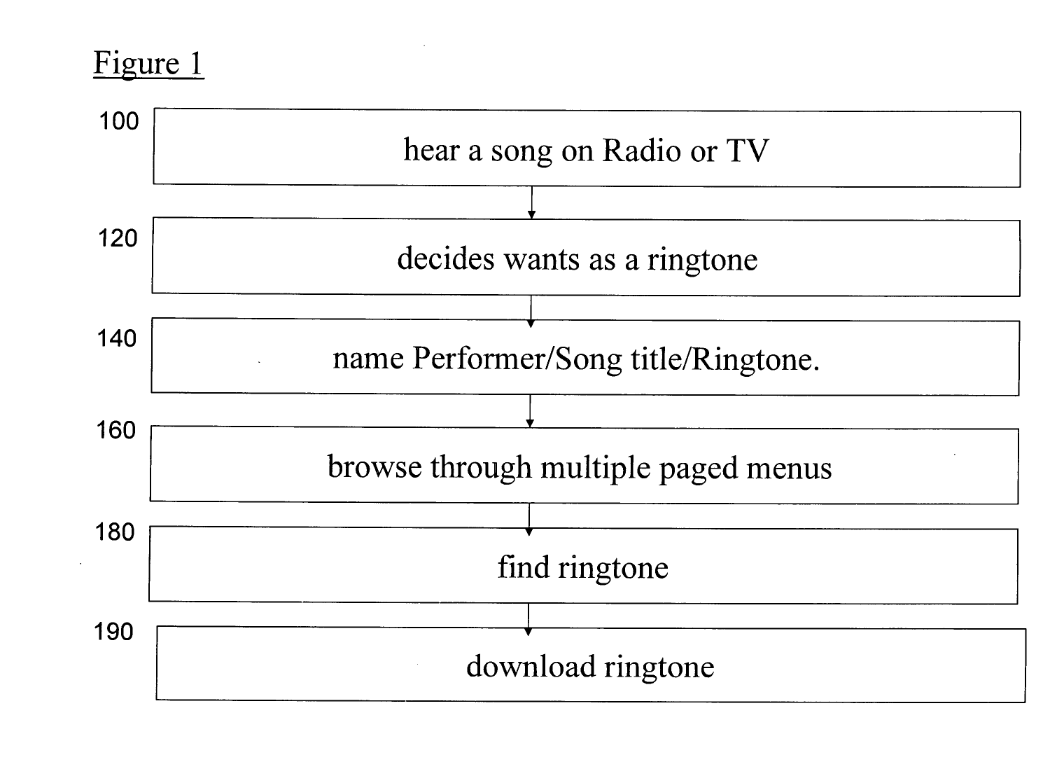

FIG. 2 is a flow chart illustrating an exemplary scenario for acquiring content according to a preferred embodiment of the present invention;

FIG. 3 is a block diagram of a first apparatus for provisioning content in an intuitive-associative manner, according to a preferred embodiment of the present invention;

FIG. 4 is a block diagram illustrating a content catalog builder according to a preferred embodiment of the present invention;

FIG. 5 shows an exemplary fingerprint database record according to a preferred embodiment of the present invention;

FIG. 6 is block diagram of a matching record generator according to a preferred embodiment of the present invention;

FIG. 7 is a block diagram illustrating a content generator according to a preferred embodiment of the present invention;

FIG. 8 is a block diagram illustrating an assembler according to a preferred embodiment of the present invention;

FIG. 9 shows an exemplary candidate item database record according to a preferred embodiment of the present invention;

FIG. 10 illustrates an exemplary multi-step GUI according to a preferred embodiment of the present invention;

FIG. 11 is a detailed block diagram of a second apparatus for provisioning content in an intuitive-associative manner, according to a preferred embodiment of the present invention;

FIG. 12 is a block diagram illustrating a third apparatus for provisioning content in an intuitive-associative manner, according to a preferred embodiment of the present invention;

FIG. 13a is a block diagram illustrating a first apparatus for people metering according to a preferred embodiment of the present invention;

FIG. 13b is a block diagram illustrating a second apparatus for people metering according to a preferred embodiment of the present invention;

FIG. 14 is a block diagram illustrating an apparatus for assembling a channel list of items (a channel play list), according to a preferred embodiment of the present invention;

FIG. 15 is flow chart illustrating a method for provisioning content in an intuitive-associative manner, according to a preferred embodiment of the present invention;

FIG. 16 is a flow chart illustrating an exemplary gambling scenario according to a preferred embodiment of the present invention;

FIG. 17 is a flow chart illustrating a billing method according to a preferred embodiment of the present invention; and

FIG. 18 is a detailed flow chart illustrating a billing method according to a preferred embodiment of the present invention.

### DESCRIPTION OF THE PREFERRED EMBODIMENTS

The present embodiments comprise an apparatus and a method for provisioning content in an intuitive-associative manner.

The principles and operation of an apparatus or a method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

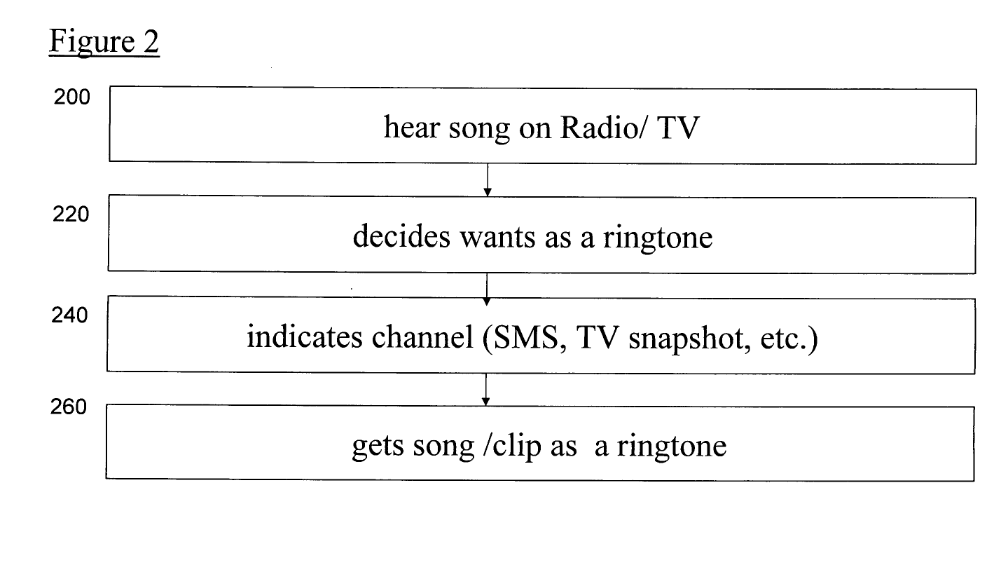

Reference is now made to FIG. 2 which is a flow chart illustrating an exemplary scenario for acquiring content according to a preferred embodiment of the present invention.

As illustrated in this exemplary scenario, according to a preferred embodiment of the present invention, a user hears a song on the radio or watches a clip on TV 200. The user likes the song or clip and decides he wants to have the song/clip as a ringtone (montone, polytone, etc.) on his cellular phone 220.

The user does not have to know or recall any detail relating specifically to the song/clip. All the user has to do is to indicate the channel where the song or clip is transmitted 240. The user provides channel identifying data in one of possible formats including but not limited to: a textual format—such as an SMS cellular phone message (for example he sends the single word text message <MTV>) to a pre-assigned telephone number, or he uses the telephone's camera to provide the message in a visual format—such as a snapshot of the TV screen where the channel logo may be found. Knowing which items are transmitted in the channel in the time frame when the user inputs the channel identifying data, the desired ringtone may be automatically located and the user may get the clip he watches as a ringtone 260.

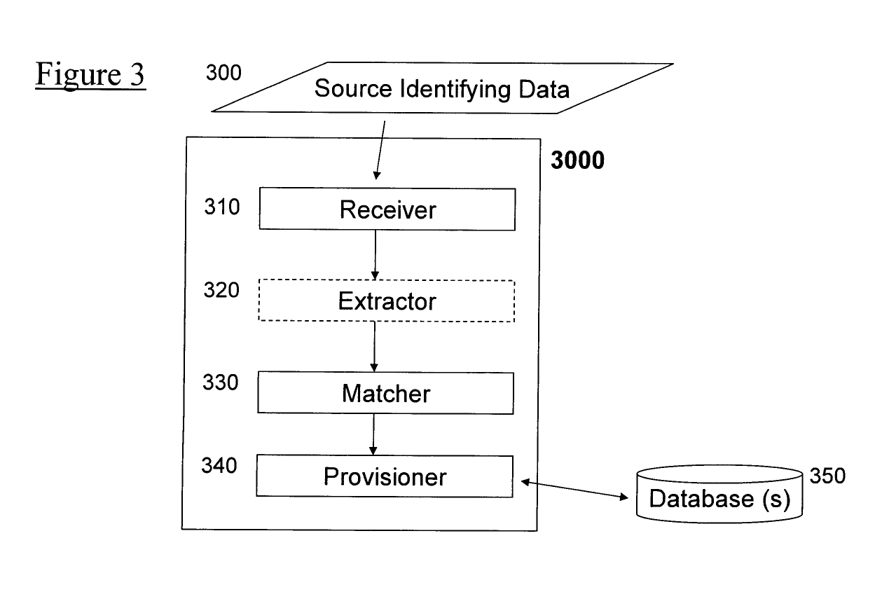

Reference is now made to FIG. 3 which is a block diagram of a first apparatus for provisioning content in an intuitive-associative manner, according to a preferred embodiment of the present invention.

The apparatus 3000, according to a preferred embodiment, is preferably located at or in association with a content provider and includes a data receiver 310, for receiving data 300 which identifies a transmission source from a user via a network which may for example be the telephone network, the cellular network or the Internet.

The source may be, but is not limited to, a broadcasting channel such a TV channel or a radio channel, a narrowcasting channel such a video on demand (VOD) channel or an internet P2P (peer to peer) data channel, or any other source.

According to a preferred embodiment, the data receiver 310 may be connected to a connector which facilitates communication with the user. The connector may connect the apparatus 3000 to an external network such as a cellular network, the Internet, a cable network, a satellite network, a wireless network, any other communication media, or a combination thereof.

The connecter may be configured to handle various aspects of the communication between the apparatus 3000 and the external network such as a cellular network, a satellite network, a wireless network, etc.

The user may input the source identifying data using a communication device, including but not limited to a mobile phone, a personal digital assist (PDA), a PC, a TV set-top box, a gaming console, an internet messenger (such as a messenger provided by Yahoo™, AOL Instant Messenger™, or MSN™), a telephony/Video software (such as Skype™), or any other known in the art communication device.

Optionally, the data provided by the user may also include a preference parameter. The preference parameter may by used by the user for expressing the user's preference(s) with regards to content item(s) the user is interested in receiving. For example, using the preference parameter the user may specify his preference for receiving media items of a certain type, such as: ringtones, web links, wall papers, etc.

Optionally, the apparatus 3000 may further include a source extractor 320, connected to the data receiver 310, for extracting an identifier of the source from the identifying data.

The identifying data may be textual data, for example—an SMS textual message.

Optionally, the source extractor 320 may use a spelling check/correction, a speech recognition based translator, a dictionary, a conversion table, or any other known in the art text processing tool, in order to extract the identifier of the source from the textual data. For example, Fix may be corrected to Fox (Fox TV).

In addition a thesaurus like functionality may also be used by the source extractor 320, thus enabling the source extractor 320 to extract the source identifier according to any synonymous identifier for the source that may be found in the source identfying data.

The identifying data may be non-textual. For example—a snap shot of a clip broadcast on MTV. The extractor 320 may be configured to use image processing tools for locating and interpreting the MTV logo (identifier) in the snap shot.

The source extractor 320 may employ other known in the art techniques as well. For example, the source extractor may utilize optical character recognition (OCR) when extracting the source identifier from a hand written message identifying the source which the user inputs using a PDA for example.

Optionally, the source extractor 320 may additionally extract the preference parameter, expressing the user's preferences with regards to the content items the user is interested in receiving, as described in greater detail hereinabove.

Optionally, the extractor 320 may communicate with a client agent, installed on a remote unit such as a user's mobile phone, for carrying out some of the source identifier extraction process.

For example, the client agent may be configured to extract the data identifying the transmission source from a sample taken from the transmission source—say, by identifying a logo (identifier) of a channel in a snap shot taken by a camera installed on the mobile phone.

The client agent may also be configured to identify a barcode presented on the screen as captured by the camera, etc. The client agent may also be configured to extract other information from a sample taken from the transmission source, such as: details of the broadcasted item, details of the performer, etc.

Optionally, the whole source identifier extraction process is carried out centrally by the extractor 320.

The apparatus 3000 may also include a matcher 330, for matching relevant items being transmitted in the source at a time frame of the user input data with one or more provisionable content item(s).

Optionally, one or more relevant item(s) are retrieved from a list of items that are transmitted in the source (a play list of the source), according to a time frame of the receiving of data identifying the source. The matcher 330 then matches the relevant items with one or more content item(s).

Preferably, the matched content items have an associative relationship with the relevant transmitted item(s). The matched content items may also include sponsored content item(s), etc. The apparatus 3000 also includes a provisioner 340, connected to the matcher, for provisioning selected content items of the matched content items to the user.

The provisioner 340 may select the content item(s) for provisioning to the user according to one or more of the following criteria (or according to any other predefined criteria): a predefined preference with respect to the content items (for example, a preference for content items that are provided by a certain content provider), information relating to the user( such as gender, age, occupation, etc.), information relating to content items, provisioning history data—general or specific to the user (for example, by taking into consideration repetitive messages received from the user on a certain day, time of the day, etc.), capabilities of a receiving device used by the user, geographic data, demographic data, socio-economical data, and selections made by the user (say by a graphical user interface as described in greater detail herein below).

Optionally, the provisioner 340 also takes into consideration the preference parameter, provided by the user as described hereinabove, when selecting content item(s) for provisioning to the user.

Optionally, the provisioner 340 may be configured to provision selected content items to the user even if the message received from the user is an empty one or if the source extractor 320 fails to extract a source identifier from the message, based on the above described criteria, applied to available content items.

For example, in the case of an empty message, the provisioner 340 may be configured to send the user a currently most popular content item. Such a most popular item may be selected using such criteria as the item provisioned to the greatest number of users, or users in the same region, or at the time frame when the user sends his empty message.

Alternatively, the apparatus 3000 may be configured to return an error message to the user when an empty message is received from the user or when the source extractor 320 fails to extract a source identifier from the message.

Preferably, the apparatus also includes a format converter that may be connected to the provisioner 340. The format converter may be used for converting a content item, to be provisioned to the user, into a format which is compatible with a type of a content receiving device which is used by the user (a specific type of a mobile phone, a specific palm pilot model, etc.).

In a preferred embodiment of the present invention, the selected content items may be provisioned to the user by the provisioner 340 as web links, including but not limited to web links delivered to the user's mobile device (such as a cellular phone) utilizing the Wireless Application Protocol (WAP). That is to say, by provisioning the selected content items as web links, a new type of an Internet Search Engine is facilitated by the apparatus 3000.

For example, the provisioner 340 may provision the content items as web links to be presented to the user using a web browser, say Microsoft™ Internet Explorer. For example, upon receiving a “MTV” bearing message from the user, a list of web links is presented to the user.

In another example, a ringback tone may be provisioned to a user. A ringback tone is a ringtone played to a caller before the user accepts the incoming call made by the caller. In the example, a cellular user may be given a web link connecting the user to a web site where the user may be able to download a ringback tone of a clip just played on MTV™. Optionally, the user may be requested to provide certain parameters in the web site, prior to being sent the desired ringback tone. The parameters may include, but are not limited to: the operator id of the user, the phone number of the user, the type of request (i.e. to download a polyphonic ringback tone), additional information regarding the desired ringback tone, etc.

Optionally, the matcher 330 may utilize information retrieved from the web using a search engine. The search engine may, but is not limited to one or more of the known search engines, such as: Google™, Yahoo™, Excite™, etc.

In one example, the matcher receives an impulsive text message from the user and uses it in a web search using the aforementioned search engine. The user is then sent a list of web sites relating to a performer of the clip just played, say on the MTV™ TV Channel.

In another example, the matcher receives an impulsive text message from the user, and carries out a search, based on the received impulsive text message in information existing in the system and/or in the search engine(s), as described hereinabove.

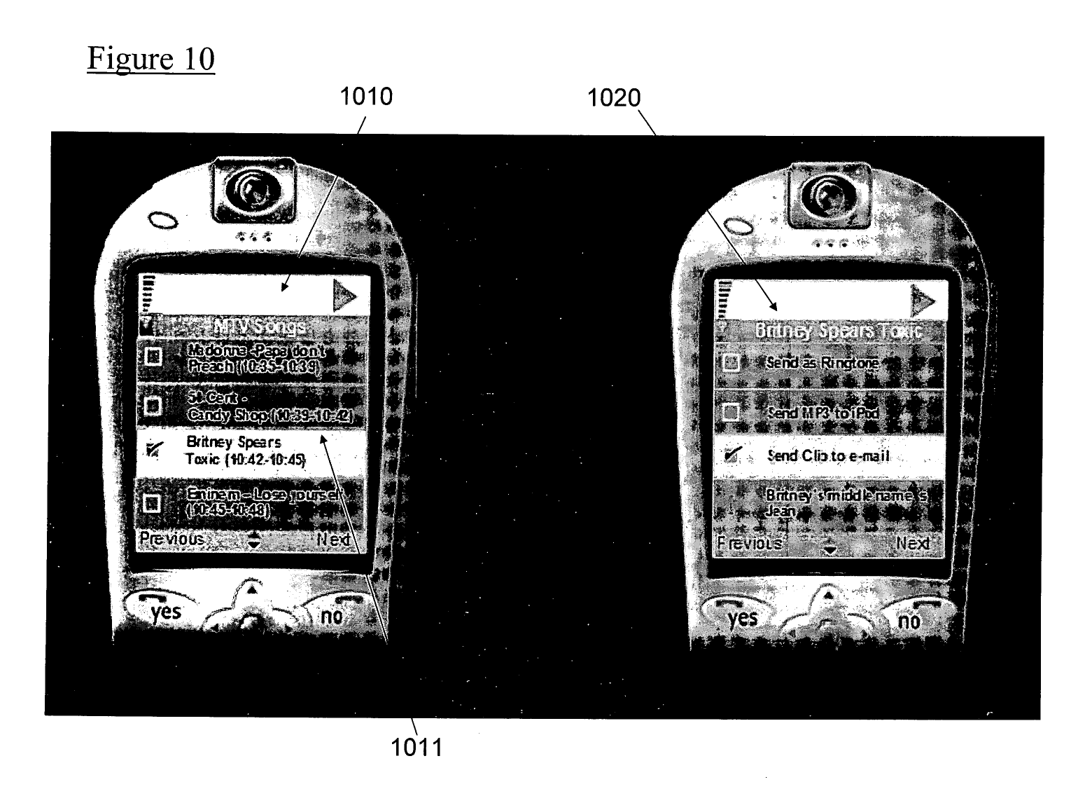

Optionally, the provisioned content items may be presented to the user using an interactive and multiple stepped interface. For example, using the multiple stepped interface, as illustrated and explained herein below using FIG. 10, the user may be asked multiple choice questions about his preferences (say with regards to: Pop music vs. Classical music, specific songs transmitted in a source identified by the user, etc), the format he wishes to receive content items in, etc.

The multiple step process may be dynamically managed by a GUI manager, as described herein below.

A content item may also be provisioned to the user in a single step scenario. For example, an SMS text message bearing “MTV” may be input, and a Beatles monotone may be sent to the user cellular unit as a response, since at the time, MTV™ happens to be broadcasting a Beatles clip.

Optionally, the provisioner 340 may be configured to verify that the user is authorized to receive the selected content items. Such verification is preferably carried out prior to provisioning to the user, say by a security management utility, such as any of the known in the art security systems or user authorization management systems.

Preferably, the provisioner 340 verifies the ability of the user to receive the selected content items, based on predefined criteria.

The predefined criteria may involve but are not limited to technical data, financial (say using a billing module as described herein below) data, operative data, or any other data. The data may be recorded in a dedicated database 350 of user profiles, connected to the provisioner 340.

According to a preferred embodiment of the present invention, the provisioner 340 may also comprise a DRM (Digital Rights Management) module which may be employed for guaranteeing that all royalties are paid to owners of copyrights in the provisioned content items.

According to a preferred embodiment of the present invention, the apparatus 3000 may also include an assembler which may be connected to the matcher 330.

The assembler may be configured to dynamically assemble a list of items (a source play list) transmitted in a source. Preferably, the list of items is a real time updated list of items transmitted in a given source with their respective transmission time frames.

In a preferred embodiment, the assembler includes an item reader, configured to read an item which is being transmitted in the source and an item identifier, for identify the transmitted item (as described herein below).

The assembler further includes a list updater, for adding identification data of the transmitted item to the list of items transmitted in the source (the source play list), together with a time frame when the item is transmitted in the source.

Optionally, the item identifier may be manually fed by an operator, with data identifying the transmitted item, say using a keyboard based user interface.

Preferably, the item identifier may also be configured to carry out a textual matching process. In the textual matching process, the item identifier matches between item and performer names, for converting differently spelled names of the same item or performer into a uniform name. For example the well-known Queen's song, alternatively represented as “Bohemian—Rhapsody” and “Bohemian-Rhapsody”, may be converted by the item identifier into a uniform name: “Bohemian Rhapsody”.

Optionally, the assembler may be used to assemble a play list of items being performed in a live event.

For example, the assembler may be used to assemble a play list of musical items being played live, in a musical show performed in a theater. In the example, the item reader, described hereinabove, picks and records each musical item performed in the musical show. An operator may then operate the item identifier, for providing identifying data for each musical item performed live and picked by the item reader, as described hereinabove.

In a similar example, the assembler may be connected to a playback system used in a concert, or to a playback system used in another “live” performance, say in a theater, as described hereinabove. The assembler may be connected to the playback system, such that the item reader, described hereinabove, may pick and record each musical item being played by the playback system. The item identifier may be fed with data identifying each performed item in an automatic manner, from the playback system. Alternatively, the item identifier may be fed with identifying data in a manual manner, by the operator, as described hereinabove.

Preferably, the item identifier may utilize a fingerprint comparison for identifying the transmitted item.

Preferably, a comparison is made by the item identifier with identifying fingerprints residing in a content catalog where each identifying fingerprint is associated with a related content item.

Thus, the assembler extracts a fingerprint from the transmitted item, using known in the art techniques, and compares the fingerprint with the identifying fingerprints in the content catalog. The comparison may also include using data pertaining to a location of the compared fingerprints within each of the compared items.

According to a preferred embodiment, the item identifier carries out the identifying of the item transmitted in the source using statistics relating to the items transmitted in the source, statistics relating to items transmitted in general, statistics relating to preferences in a geographic region of the source, etc.

For example, the statistics for a source may list the most popular items in the source. The item identifier may be configured to compare the fingerprint extracted for the item with the fingerprints of the most popular items in the source, as indicated by list. Only if the item identifier fails to identify the item using a fingerprint comparison with the most popular items, does the item identifier carry out a more general search in the content catalog, for finding a fingerprint identifying the item.

According to a preferred embodiment of the present invention, the assembler may also include a statistics generator, configured to generate and collect statistics relating to the items transmitted in the source. For example, the statistics generator may generate a list of the ten most popular items in a specific source by some measure, or the ten most frequently played items of the source.

The statistics for a source may relate to various aspects, including but not limited to: the most frequently played items in the source, the most popular performer, the most popular genre of songs in the source, the most popular album, etc.

The statistics generated by the statistics generation may be used for rating the popularity of items in general and in the specific source in particular.

The statistics may also serve as an indication of the status of the source. For example, if a certain item is played over and over again in a certain source, it may be indicative of a technical problem occurring in the source.

Preferably, the assembler may utilize the statistics generated for the source through the process of creating and updating the list of items transmitted in the source (the play list for the source). As described in further detail hereinabove.

In a preferred embodiment of the present invention, the assembler is configured to treat time gaps between two items that are consecutively transmitted in the source in a variety of ways.

For example, the gap may be skipped (say when the gap consists of talks between two songs). In another example, a commercial may be added to the assembled list of items (to be linked with content items such as a ringtone of the song played in the commercial or a site where the product offered in the commercial is sold.)

According to a preferred embodiment, the apparatus 3000 may also include a content catalog builder.

The content catalog builder is used for building the content catalog discussed hereinabove.

In a preferred embodiment of the present invention, the content catalog builder includes an item receiver, for receiving a content item such as a video clip or a song, and an identification receiver, for receiving identifying data relating to the content item such as a name of a song, a name of a performer, a name of an album, a show name, etc.

Optionally, the identification receiver further converts the identifying data into a standard format, resultant upon applying a predefined set of rules on the identifying data. The standardization of the identifying data may allow more convenient item matching and provisioning, as well as a standard for the play list assembled by the assembler 330, as described hereinabove.

For example, there may be defined a rule that words in a song name are separated by a single blank character. Consequently, the Queen's song name spelled in the identifying data as: “Bohemian—Rhapsody” is converted by the textual converter into “Bohemian Rhapsody”.

Optionally, the content catalog builder further includes a fingerprint extractor, for extracting an identifying fingerprint from the content item, as described in greater detail herein below, and a content updater for updating the content catalog with the identifying fingerprint and with the identification data relating to the identifying fingerprint. Preferably, the content updater may also update the content catalog with data pertaining to a location of the fingerprint within the content item.

The apparatus 3000 may also include a history generator, connected to the provisioner 340, for recording history relating to provisioning of content items to the user.

The following paragraphs provide a detailed description of components of the above discussed apparatus.

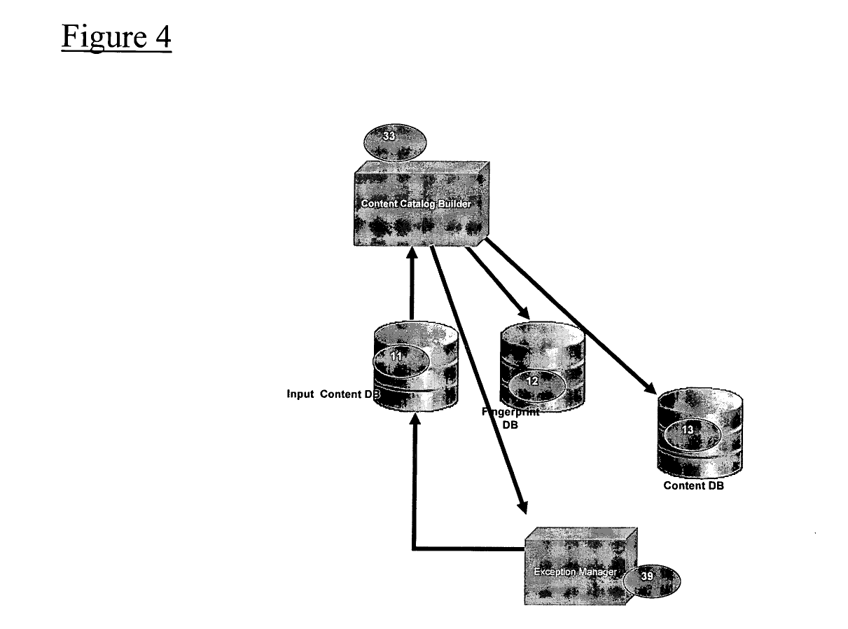

Reference is now made to FIG. 4 which is a block diagram illustrating a content catalog builder according to a preferred embodiment of the present invention.

According to a preferred embodiment of the present invention, the content catalog comprises a fingerprint database 12 and a content database 13.

In a preferred embodiment, the content catalog builder main module 33 inputs a content item from an input content database 11, the content catalog in its turn may be populated with content items from a variety of origins, including but not limited to: external Internet content providers, music albums, broadcast video clips etc.

In a preferred embodiment the content catalog builder further includes an exception manager 39.

Optionally, a content item is provided together with identification data pertaining thereto. The identification data may include, but is not limited to, details such as a song name, an album name, a performer name, a TV show, etc.

Alternatively, the content item may be provided without such identification data, in which case the exception manager 39 may prompt an operator of the apparatus 3000 to manually provide identification data for the content item.

According to a preferred embodiment, the content catalog builder is configured to extract an identifying fingerprint from the content item and to update the fingerprint database 12 with the identifying fingerprint, the content item identification data may be added to the content database 13, with its identifying fingerprint. Optionally, the content item itself may also be stored by the apparatus 3000, say in a local content item database.

There are many known in the art methods for extracting a fingerprint from a content item. According to some of the known in the art techniques, a fingerprint consists of 32 bits which are extracted from a sub block of the content item.

A fingerprint may be generated for every sub block of the content item. As a fingerprint is a significantly smaller piece of data than the usually high quality content item, the fingerprint database may be loaded with a relatively large number of fingerprints, and may be used for an accurate and fast identification of transmitted items, as described in greater detail herein below.

In a preferred embodiment, the fingerprint may be further shortened, say from 32 bits to 28 bits, by any known in the art techniques, say by retaining the first most significant bits.

In a preferred embodiment, the fingerprint database may include an immense number of fingerprint records and be divided into a number of files.

According to preferred embodiment, the fingerprints may be treated as integer numbers, sorted, and divided between the files according to their numerical value. For example, a non shortened 32 bit fingerprint may be treated as a 32 bit integer number. With this embodiment, each file holds a consecutive range of these numbers, and the total number of files covers the whole range of possible values.

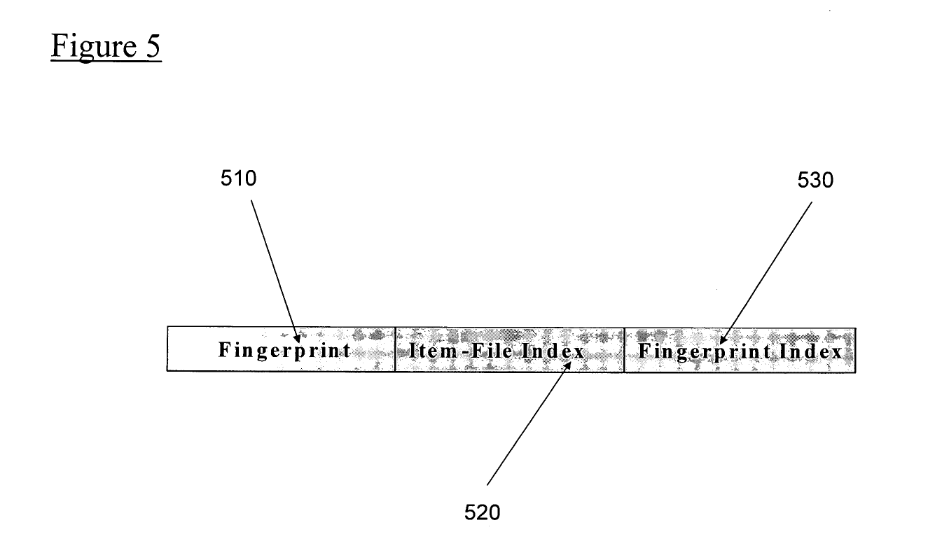

Reference is now made to FIG. 5 which shows an exemplary fingerprint database record according to a preferred embodiment of the present invention.

According to a preferred embodiment, each file contains all the fingerprints that fall within its range. Each fingerprint record comprises the fingerprint 510 associated with an item-file index 520 and a fingerprint index 530.

The fingerprints in the file are ordered so as to enable quick search through the fingerprint database.

The item file index 520 is a unique identifier given to any content item input the system. This number is unique for any recording or version of the item. For example, each of two different performances of the same song, one from a studio recording and the other from a live recording, is assigned a different item-file index 520.

The fingerprint index 530 indicates the position of the fingerprint within the content item. That is to say, the position of the sub block, the fingerprint belongs to, relative to the beginning of the content item.

This index 530 may be used together with the fingerprint 510, for identifying a source transmitted item, by the assembler, when dynamically assembling the list of items (play list) for the source, as discussed in greater detail hereinabove.

The content database 13 record may list identifiers and descriptors for the specific content item. The identifiers and descriptors may contain (in addition to the unique item-file index 520), but is not limited to: the name of a performer, the name of a song, the name of an album, the name of a TV show, and other relevant information pertaining to the content item.

The content database 13 is sorted according to the song file index, for fast retrieval of information in the real time system. Preferably, the content database 13 is also indexed according to a performer name, a show name, etc.

In a preferred embodiment, a content item may be provided by a content provider who chooses to retain the content item within is private premises.

In such a case, the content catalog builder may be implemented in a distributed manner. The content provider may be provided with the means for extracting a fingerprint from a content item according to a standard which is defined for the apparatus 3000.

Thus with this embodiment, the identifying fingerprint extraction phase is carried out by a module of the content catalog builder which is implemented at the content provider.

Preferably, the content catalog builder further includes a remote content updater that may be included in a module provided to a content provider. The remote content updater may be operated for remotely updating the content catalog with an identifying fingerprint pointing to a remotely stored content item, retained in the premises of a content provider, with identification details of the remotely stored content item, etc.

The resultant fingerprint and identification data relating to the content item are used by centrally implemented modules of the content catalog builder, handling the updating of the catalog databases as described hereinabove.

According to a preferred embodiment of the present invention, identifying fingerprints for different types of content items (like audio, video, or any other type) may be used for identifying transmitted items, say by the assembler.

According to a preferred embodiment of the present invention, the content catalog builder further implements an initial step for verifying that the input content item does not already exist in the database. Preferably, the initial step may be based on existing fingerprints in the catalog, their related identification data, or both.

As described hereinabove, the matcher 330 according to a preferred embodiment of the present invention is configured to retrieve one or more relevant item(s) from an updated list of items transmitted in the source (a play list of the source).

Optionally, the relevant items are retrieved by the matcher 330 according to a time frame when the source identifying data is inputted such as a time stamp associated with a user sent message carrying the source identifying data. Optionally, the time stamp may be corrected, so as to eliminate network latency and user reaction time interferences.

The matcher 330 is also configured to match the relevant items with one or more content item(s).

Preferably, the matched content items may have an associative relationship with the relevant transmitted item(s). The matched content items may also include sponsored content item(s).

The matcher 330 may be configured to match the relevant source transmitted items with contents items such as songs, video clips, sport clips, news clips, ringtones etc.

The matching of content items may be carried out utilizing a predetermined set of rules. An exemplary rule may define that if Madona's “Like a virgin” is played on the source, any Madona clip may be matched, while an alternative rule may define that only a “Like a virgin” Madona clip may be matched.

Preferably, the matcher 330 is a dynamic component, bearing a capacity to match the relevant transmitted item(s) with content items included in a constantly growing number of available content items.

According to a preferred embodiment, the matcher 330 retrieves each of the relevant transmitted items from the list of transmitted items pertaining to the source (the source play list), and fetches corresponding matching data records that match the item to respective content items. Optionally, these matching data records may reside on the content catalog, discussed hereinabove.

Each of the matching data records may point to matching content items that are centrally stored in a content item catalog, in a centralized architecture, as described herein below.

The matching data record may also point to a content item residing in the premises of a content provider, in a distributed architecture, as described hereinbelow.

According to a preferred embodiment of the present invention, the matching may also be carried out on the fly, without using the above discussed matching data record(s), searching for matched content items for the relevant transmitted content items ad hock, per a user input/request.

In a preferred embodiment, the matcher 330 may also communicate with affiliate content providers, in real time, for receiving from the affiliate content providers matching content items, thus implementing a fully decentralized architecture.

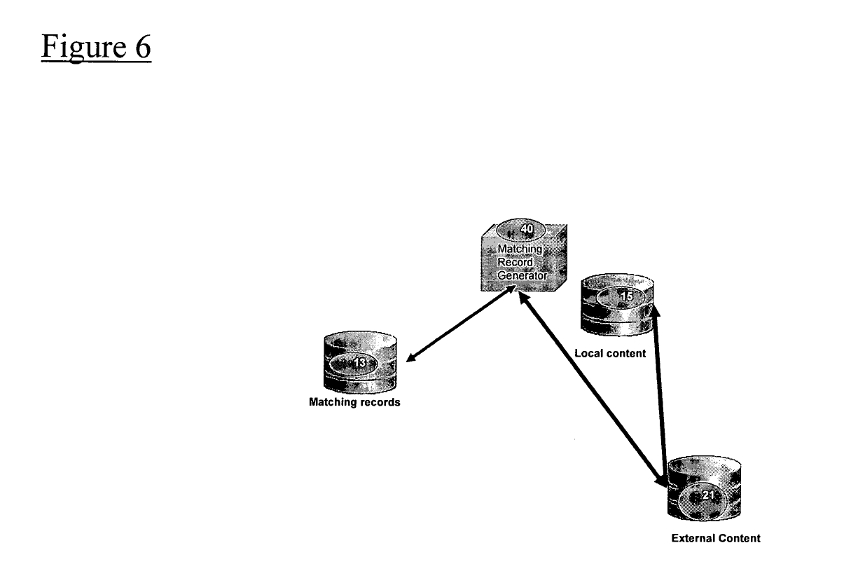

Reference is now made to FIG. 6 which is block diagram of a matching record generator according to a preferred embodiment of the present invention.

According to a preferred embodiment, the apparatus 3000 may include a matching record generator 40, for generating the matching record(s), discussed hereinabove.

A preferred embodiment of the present invention may implement a centralized architecture. In the centralized architecture all content items are centrally stored, in one location.

In this case, the matching record generator 40 is fed with new content items that are stored centrally, and goes through relevant identifiers and descriptors of the new items for finding matches between each of the new content items and other content items.

For example, a match may be found between two content items having the same performer or the same song name. The match found is recorded as a matching record 13 that may be used as described hereinabove. Optionally, the matching records reside in a content catalog, as described hereinabove. The matching records 13 point to centrally stored content items 15.

The type of content may also be noted. Content items may also be indirectly related, a special relevance marker may accordingly be included in the matching record. For example, a partial match between two content items, resulting from statistical data indicating that people who buy the one very often buy the other may also be recorded.

A preferred embodiment of the present invention may implement a distributed architecture. In this embodiment, a matching record 13 may point to a centrally stored content item.

However, in this preferred embodiment, a matching record 13 may also point to a content item which is stored in premises of an external content provider 21. Thus with the distributed architecture, some of the content items may be retained by external content provider(s) in their own databases 21.

Each of the content providers may install a module that provides identifiers/descriptors relating to a content item.

The matching record generator 40 generates one or more matching data records linking the content item to other content items. Each matching data record may also include an identifier of an affiliate content provider.

As described hereinabove, a preferred embodiment of the present invention may implement a fully distributed architecture.

With a fully distributed architecture, the matching is carried out on the fly, as described hereinabove, and no matching data record is needed in advance.

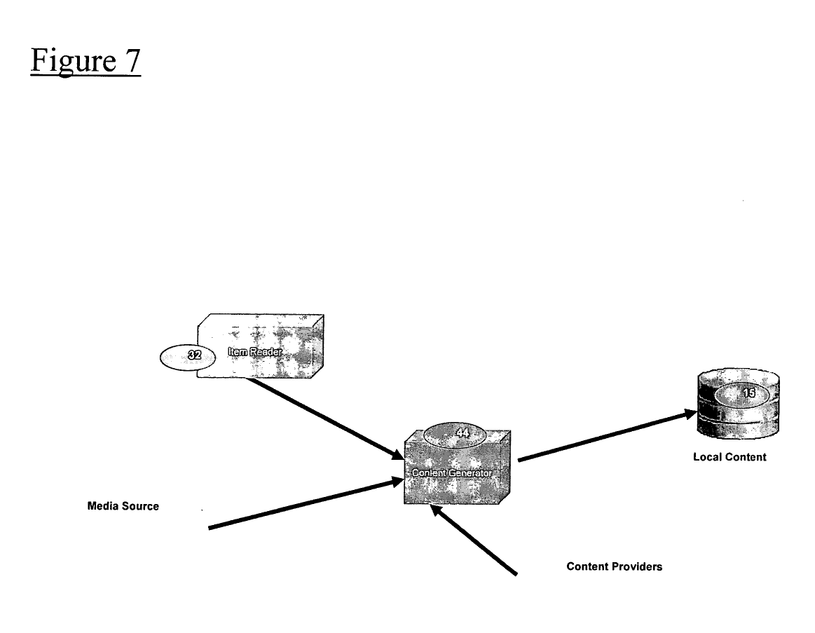

Reference is now made to FIG. 7 which is a block diagram illustrating a content generator according to a preferred embodiment of the present invention.

In a preferred embodiment of the present invention, the apparatus 300 may further include a content generator, for automatically generating a new content item (such as a ringtone—monotone/polytone/etc.) from an existing content item or from selected parts of an exiting content item.

Optionally, the content generator may be used for automatically generating snipped versions of existing content items. The snipped versions may be converted to a any one of a variety of content formats, including but not limited to ringtones (monotones, polytones, ringback tones—played to a caller before a callee accepts the call, ringback tones—played to a caller prior to his call being answered, etc.), video clips, etc.

For example, the content generator may be capable of identifying chorus parts in a full song track and for automatically converting the chorus parts into ringtones. The content generator may identify the chorus by detecting fingerprint correlation among different blocks of the same song. Preferably, the content generator may further process the resultant ringtone so as to generate a polyphonic ringtone (Polytone).

In another example, the content generator may receive streamed video and audio of a live soccer match, identify a goal by detecting audience applause, and automatically generate a short video content item of the goal.

The content generator may detect the audience applause by finding fingerprint correlation among a sequence of blocks that differ from blocks that precede or follow the sequence. Preferably, the content generator employs decision logic for detecting interesting parts like a chorus, a goal, etc.

In a preferred embodiment, the generated content items are immediately fingerprinted and added to the content catalog by the content catalog builder, as described in greater detail hereinabove.

The content generator may be fed by an item reader 32, which reads items being transmitted in a source such as a broadcasting channel, content provided by external content providers, a media source such as a compact disc, or any other content source.

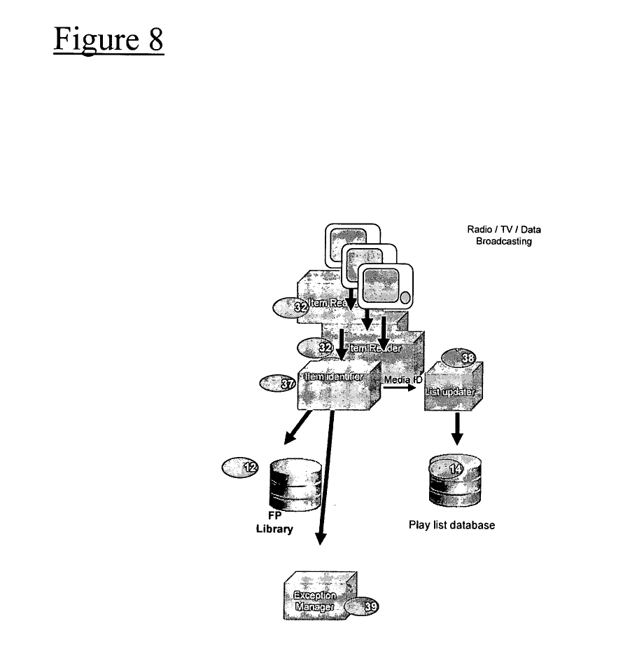

Reference is now made to FIG. 8 which a block diagram illustrating an assembler according to a preferred embodiment of the present invention.

As described hereinabove, in a preferred embodiment of the present invention, the apparatus 3000 includes an assembler, for dynamically assembling the list of items.

Preferably, the assembling includes reading an item as the item is being transmitted in the source, be it a broadcasting channel such a TV channel or a radio channel, a narrowcasting channel such a video on demand (VOD) channel or a P2P data channel, or any other source.

The assembler identifies the item, and adds identification data of the identified transmitted item and a time frame of transmission of the identified transmitted item to a list of items pertaining to the source (a source play list).

Preferably, the assembler may also dynamically generate statistics relating to transmitted items in the source(s). For example, the assembler may provide a list of most frequently played items per a specific source.

The assembler may be connected to several sources, in order to generate a specific list of items (play list) for each of the sources, in real time.

An exemplary assembler may include, according to a preferred embodiment of the present invention, an item reader (32), connected to a sampled source, for reading items transmitted in the source.

The assembler further includes an item identifier (37), fed with the read items, which may be locally or remotely connected to the item reader.

The item identifier (37) generates fingerprints from the fed items as described hereinabove for the content catalog builder.

Preferably, the content identifier (37) may also have access to the fingerprint database of the content catalog (12). The item identifier (37) compares fingerprints of the transmitted item (audio/video/other) to those of identifying fingerprints in the fingerprint database of the content catalog (12), and a preliminary list of candidate content items is generated.

The candidate list includes a list of identical fingerprints, associated with candidate content items, for each sub-block of the transmitted item. Each fingerprint in the list is represented in a candidate database where each record corresponds to one of the identical fingerprints in the list.

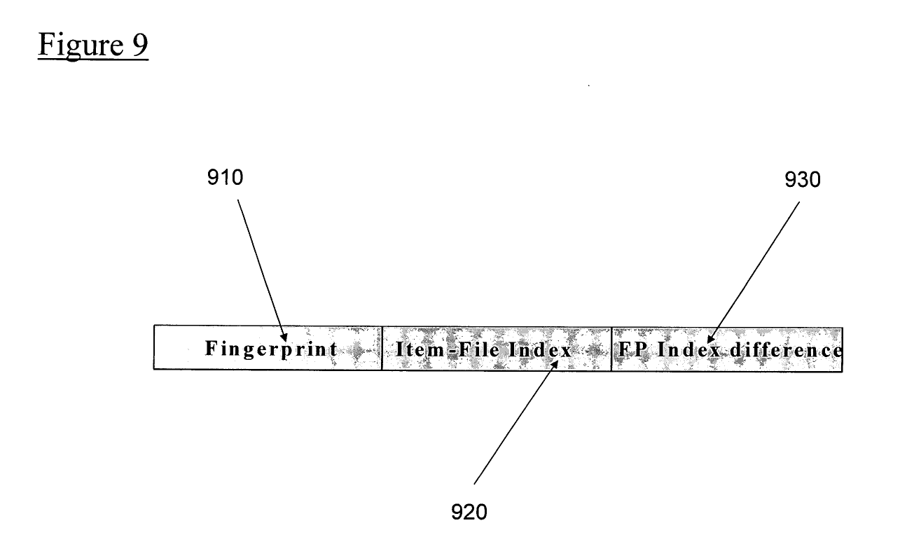

The record consists of three portions, as shown in FIG. 9: The fingerprint 910, the item-file index 920, and a fingerprint index difference 930. The finger print index difference indicates the difference in block location between the transmitted item and a candidate content item.

The item identifier (37) may include a decision rule engine.

The candidate database records may be transferred together with occurrence counters to the decision rule engine. Each of the occurrence counters indicates the number of fingerprints found for each candidate. That is to say, each occurrence counter gives the number of candidate records having the same item-file index 920.

The item identifier may then incorporate into the process data relating to available relevant statistics and other data.

The incorporated data includes but is not limited to one or more of the following: most frequently played items in the specific source, statistics relating to history data pertaining to transmitted items in the source according to the day of the week and the hour, music preferences according to a geographic region (language, type of music, etc.), a predefined source play list, statistics and data relating to general popularity of songs or performers, type of content characteristic of the source (say, video clips for MTV), and music genre typical of the source.

For example, when a classical music channel list is being extracted, if two content items are identified as relevant, one being Vivaldi and another one being Madona, the Vivaldi content item is more likely to be the item which is transmitted in the classical music channel and is thus the one identified by the item identifier (37).

According to a preferred embodiment, the assembler may use one or more known in the art algorithms for identifying the read item. More preferably, the assembler may include an artificial intelligence tool, as known in the art, for assisting in identification of the items being transmitted over the source and assembling of the list of items (play list) for each source. For example, a voice recognition algorithm may be employed to extract repeated lines from a chorus in a song and choose a name for the song based on the repeated lines.

The assembler further includes a play list creator 38, for creating and storing play list database records of the identified transmitted items, for each source, in a play list database 14.

As described hereinabove, the apparatus 3000 according to a preferred embodiment of the present invention may further include a connector, functioning as a gateway between the apparatus parts and external networks such as a cellular network, an IP (internet protocol) network, a telephone network, and a private network, on which the user is located. The connector may use SMS, WAP, push WAP, MMS, E-Mails, IP, DTMF, etc.

The connector is aware of the system events that require generation of notification or sending of information to the subscriber. For each of the events the connector operates the delivery logic of that event. The delivery logic depends on both the specific event and the specific subscriber delivery rules.

The connector may further employ the format converter, described hereinabove, for converting a content item into a format usable by a receiving device used by the user.

According to a preferred embodiment of the present invention, the connector is a part of the provisioner 340, described hereinabove.

According to a preferred embodiment, the provisioner 340 may further include a graphical user interface (GUI) manager.

The GUI manager may dynamically design interactive graphical user interfaces, customized dynamically according to user specific parameters, user usage history, content item type, the identified source, inserted advertisements, location of the user (say to insert location specific data into the GUI pages as presented to the user by the provisioner), type of a device which the user uses, etc.

Preferably, the GUI is dynamically configurable, in real time, for each user, taking in consideration attributes of a specific device used by the user, such as a screen type, audio capabilities, internal memory of the device, etc.

According to a preferred embodiment, the GUI manager introduces other considerations into the GUI dynamic design process.

The GUI manager may present the selected content items to the user in an order which is set according to commercial considerations. For example, a certain priority may be granted to content items of a certain content provider, so that these items are presented first. In another example, salable content items that are more profitable are presented first.

The GUI manager may present the provisioned content items to the user in an interactive graphical user interface that may include one or more pages. With the interactive graphical user interface, the user may interact with the apparatus 3000 for providing information relating to the preferences of the user with regards to types of content items, format of the content items, etc.

The user may be exposed to advertisements, business partner links, and the like, that may be inserted into GUI pages presented to the user during the interaction with the apparatus 3000.

Reference is now made to FIG. 10 which illustrates an exemplary multi-step GUI according to a preferred embodiment of the present invention.

The specific exemplary GUI, includes a first dynamic page 1010 presenting a list of content items to the user. The most likely content the user is believed to be interested in is highlighted 1011 (Britney Spears—Toxic) and set as default. Upon receiving the user answer, a second page 1020 is presented to the user where the user may specify in what format and way he wishes to receive the content item (a clip which is sent by e-mail in this example).

According to a preferred embodiment of the present invention, the apparatus 3000 includes a history recorder, associated with the provisioner 340, for recording history relating to content provisioning to the user. The recorded history may serve to generate various statistics relating to content provisioning, as well as to generate rating data, as described in greater detail below.

The recorded history may further serve as a back-up for the user, thus providing a stickiness service, meaning a service in which the provisioned content items stick with the user.

For example, a user who is registered as a subscriber of the apparatus may use a history record, saved for him by the history recorder, to re-download content items which were provisioned to the user in the past.

In another example, a user may be allowed to download content items previously provisioned to him for a web site. The web site may be accessed by the user from an Internet Browser on a personal computer (such as by Microsoft™ Explorer), by a cellular mobile unit, using Wireless Application Protocol (WAP), etc.

In a further example, a registered user who buys an MP3 song and receives it to his cellular phone, say as a monotone, may be able to receive this content item to a new cellular device he buys without having to purchase the item again.

According to a preferred embodiment, the history recorder may also be used for producing statistics relating to content purchasing patterns by users. For example—which content items are purchased, by whom, in what format, induced by which clip, or advertisement, and in which source was the clip or advertisement transmitted. As described in greater detail herein below.

Preferably, the history recorder updates a user profile and behavior database, described herein below. The user profile and behavior database stores user profiles and subscription data, predefined by an operator of the apparatus 3000 together with provision history, billing data, etc.

The profile and behavior database may be used for improving the user experience and for predicting which content items the user is more likely to be interested in.

Preferably, the apparatus may further include a statistically based logic, employed for predicting which item the user is likely to be interested in next, based on historic data generated by the history recorder. Details of the item are then forward to the GUI manager for insertion into the GUI page(s) presented to the user.

According to a preferred embodiment, the apparatus may further include a billing module which may be connected to the provisioner 340, configurable to implement a billing policy to be determined by an operator of the apparatus 3000 or his business partners. Preferably, the billing module may be connected to a DRM (Digital Rights Management), for guaranteeing copyright owners royalties, as described in greater detail herein below.

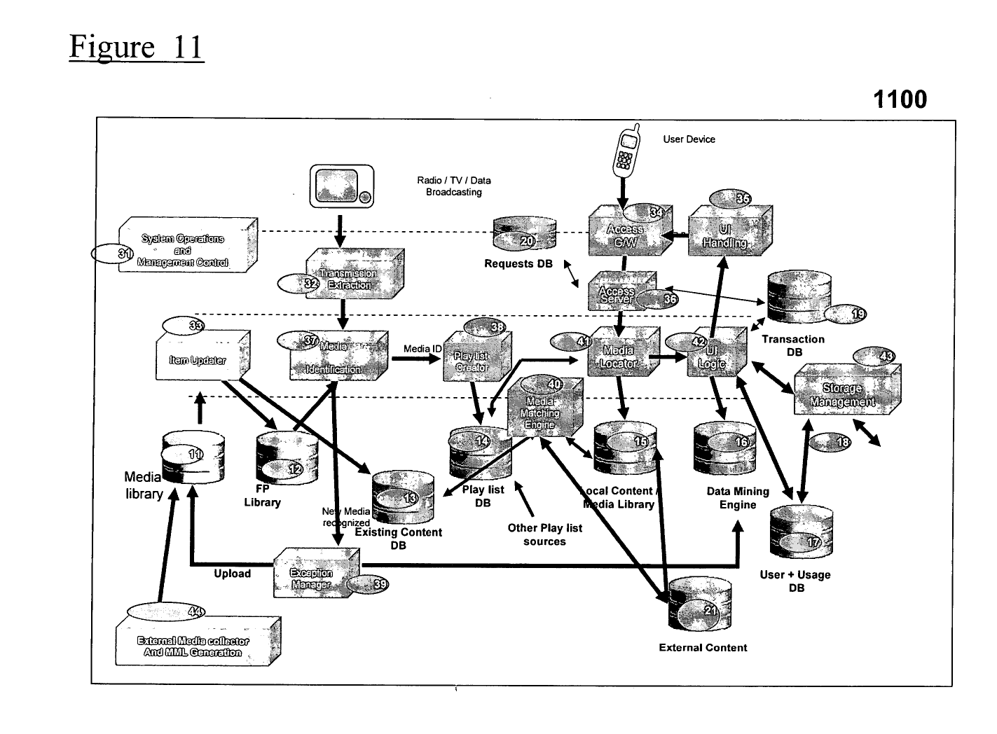

Reference is now made to FIG. 11 which is a detailed block diagram of a second apparatus for provisioning content in an intuitive-associative manner, according to a preferred embodiment of the present invention.

An alternative or additional apparatus 1100 according to a preferred embodiment of the present invention includes a system operations/management control unit 31 for monitoring and managing the apparatus 1100.

The apparatus further includes a transmission extraction unit 32 for extracting items from a TV/Radio/Data or other channel, a media identification unit 37 for identifying channel extracted items (automatically using a fingerprint library 12 or manually using an exception manager 39 for user identification of items, as described in detail hereinabove), and a play list creator 38 for generating a play list for each channel and storing the list in a dedicated play list database 14 while saving the content item itself in an existing content database 13.

The existing content database 13 is fed by a media catalog engine 40 which process items residing in a local content/media library 15 as well as in external content databases 21, and by the play list creator 38 (thus adding content as well as updating the channel play list).

The existing content database 13 is also updated by the item updater 33 which reads items to be fingerprinted and stored from an input media library 11, which is fed by external media collectors 44 that may be operated by an external content provider and by the exception manager 39. The exception manager 39 is used when a user needs to provide missing details identifying a content item. The item updater 33 updates the fingerprint library 12 and the existing content database 13.

The apparatus 1100 further includes several units that are employed for communicating with a user that is induced to impulsively buy content items, say by a clip on a TV channel, that the user watches, as described hereinabove.

The apparatus units that are employed for communicating with the user, include, but are not limited to: an access gateway 34—connecting the apparatus 1100 to other networks, a user request database 20—for storing user requests, a user interface handling unit 35, an access server 36 which translates user requests into transactions, a transaction database 19, a user interface logic 42, a media locator for inserting selected media items to the pages presented to the user while provisioning selected relevant items to the user, and a user management database 17—for storing user profiles and history data pertaining to provisioning of content items to the use.

The apparatus 1100 may further include a storage management utility 43—for managing the various databases employed by the apparatus 1100, and a data mining engine 16 for generating various statistics, as described in greater detail hereinabove.

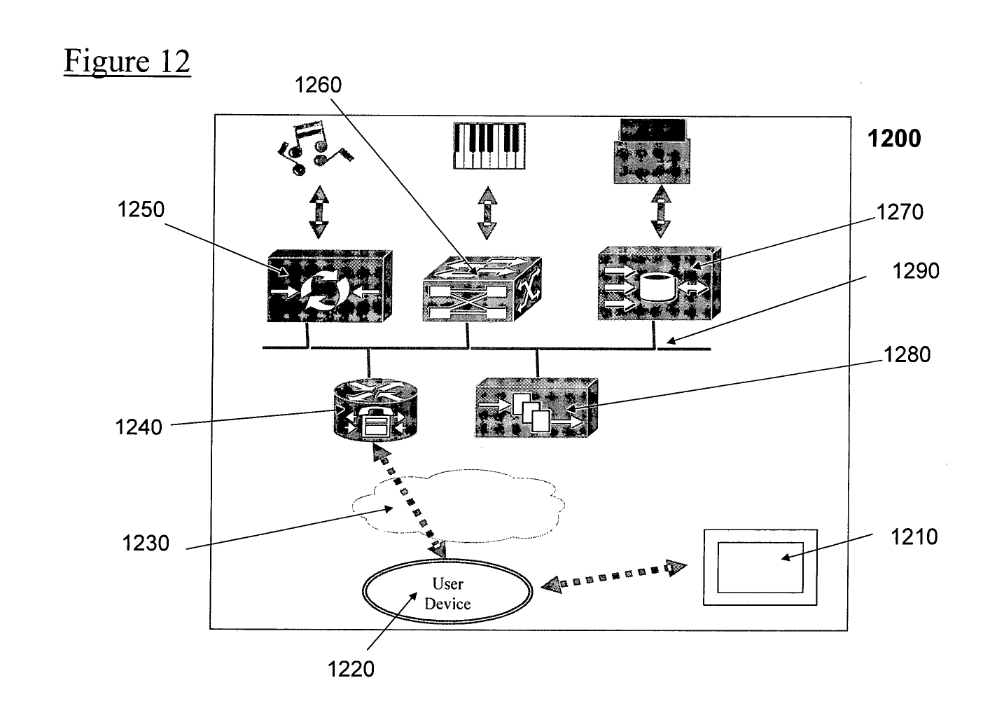

Reference is now made to FIG. 12 which is a block diagram illustrating a third apparatus for provisioning content in an intuitive-associative manner, according to a preferred embodiment of the present invention.

The apparatus 1200 according to a preferred embodiment of the present invention comprises dedicated servers (1240-1280), connected in a wired network 1290, each server implementing one or more part(s) of the apparatus 1200.

The apparatus 1200 communicates with a user device 1220 which is connected to an external network 1230. The external network 1230 may include, but is not limited to, any one way or two way communication system, such as a cellular system, e.g. GSM, GPRS, Edge, TDMA, CDMA to WCDMA, PHS, FOMA, from a first generation network to advanced generations like a second, a third, or a fourth generation cellular system, fixed line telephony, cable TV network, wired and wireless Internet, infrared, RF, etc.

The communication is carried out by the apparatus 1200 utilizing a data receiver 1240 which comprises a connecter that is used as a gateway, connecting the wired network 1290 to the external network 1230.

The connecter handles various aspects of communication between the apparatus 1200 and the external network 1230, as described in greater detail hereinabove.

The data receiver 1240 inputs the user sent message which comprises an identifier of the source 1210 inducing the impulsive purchase of a content item by the user, as described hereinabove.

The apparatus 1200 also includes a content item generator 1250 which is used to generate one or more new content items from an existing content item, as described hereinabove. For example, the content generator may be employed to generate a new ringtone(monotone/polytone) and a cellular clip from an input Madona clip.

The apparatus 1200 further comprises a source play list (source list of items) assembler 1270, for assembling a real time play list of each source, utilizing internal and external data, as described in greater detail hereinabove.

The apparatus also include a matcher 1260, as described hereinabove. The matcher 1260 is configured to retrieve relevant items being transmitted in the source from the channel specific play list. The matcher 1260 then matches the relevant items with content items.

The apparatus 1200 also includes a provisioner 1280 which is used to provision selected items of the matched content items to the user, optionally employing a GUI manager as described in greater detail hereinabove.

People Meter

In a preferred embodiment of the present invention, a people meter is introduced.

A people meter is a device for measuring how many people listen (or are exposed) to radio, TV, cable, etc, and to which stations their radios or TVs are tuned.

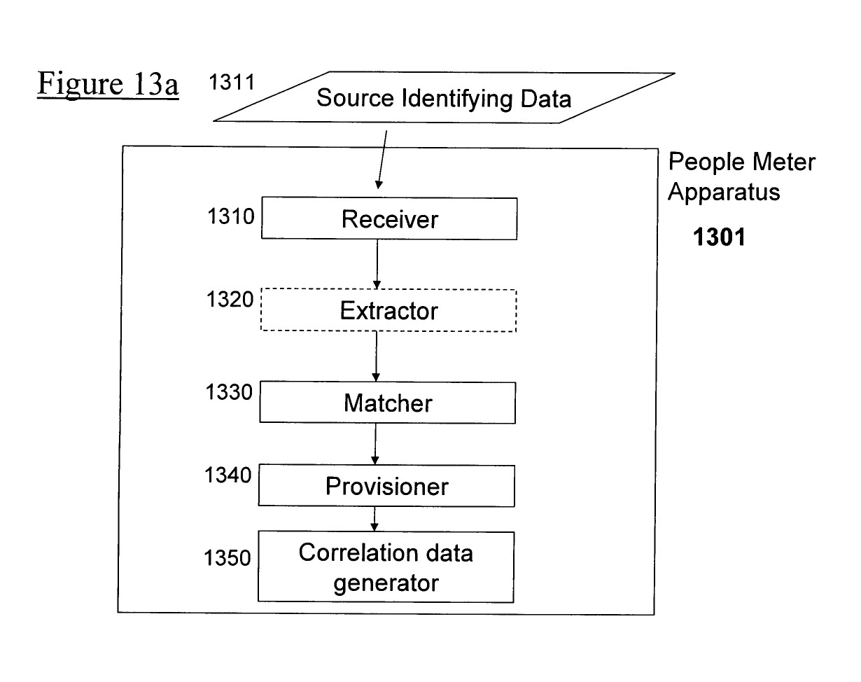

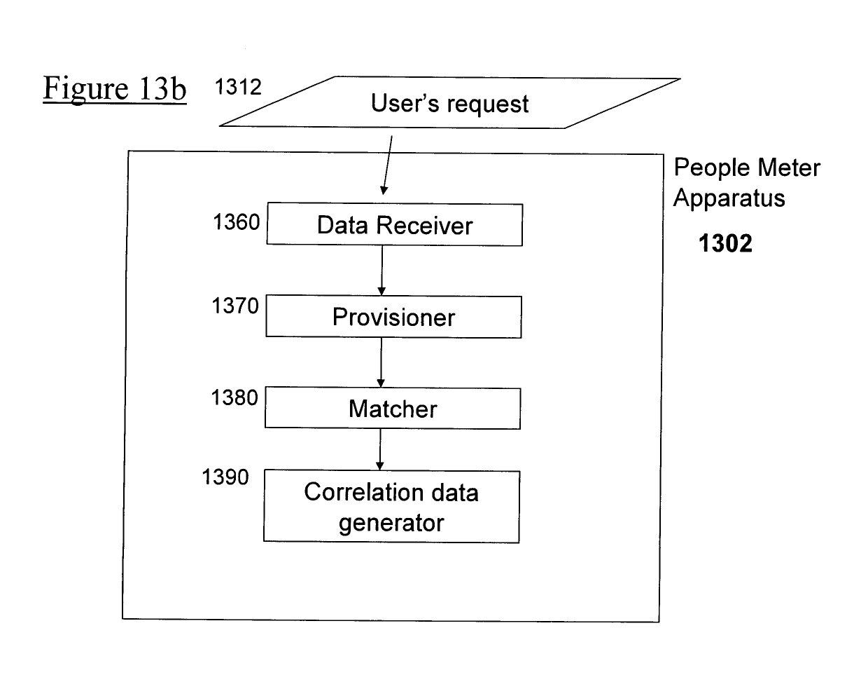

An apparatus according to a preferred embodiment of the present invention, as described using FIG. 13a herein below, may have in its databases, data that may include, but is not limited to:
1. Who is the user, or the group of users
2. What channel the user watches/listens to (according to the input user, message, e.g. SMS)
3. At what time the purchase happens (since the system is a real time system)
4. What show/advertisement/etc. is transmitted in the channel at a time frame when the user sends his message (the show being retrieved from an internally generated or externally provided play list, from a program guide, or from another source)
5. What content the user buys or requests (since we give the user a link for the content data or content itself)
6. What type of content has the user bought in the past (using the recorded history data relating to content item provisioned to the user)
7. Geographical, demographic, or socio-economic data.

For example, an apparatus for people metering as described herein below and illustrated using FIG. 13A, has a capacity to provide correlation data statistic information that indicates what percentage of the users actually buy content, while listening to which TV show or being exposed to what promotion, in which source, at what time, what content items are bought, geographic/demographic/socio-economic profile of the users who actually buy, etc.

That is to say, an apparatus for people metering as described herein below and illustrated using FIG. 13A indicates how effectively the specific promotion/show induces the purchase of items by a user, based on gathered data that directly links the specific item transmitted in the source and the provisioned items, actually purchased by a user.

For example, an apparatus an apparatus for people metering, as described herein below, may be used to analyze which factors influence the frequently certain users buy certain content items, content items belonging to a certain genre of content items, etc.

In another example, an apparatus for people metering as described herein below, may be used to indicate how the effectiveness of a specific promotion varies by transmission of the promotion on specific source(s), at certain hours, by the number of times the promotion is shown at certain hours, etc.

Reference is now made to FIG. 13a which is a block diagram illustrating a first apparatus for people metering according to a preferred embodiment of the present invention.

An apparatus 1301 according to a preferred embodiment includes a data receiver 1310, for receiving source identifying data 1311 from a user.

The apparatus 1301 may further include a source extractor 1320, connected to the data receiver 1310, for extracting an identifier of the source from the input source identifying data 1311.

The apparatus 1301 also comprises a matcher 1330, for matching relevant items being transmitted in the source when the user sends the data with content items.

Optionally, the matcher 1330 automatically retrieves one or more relevant item(s) from an updated list of items transmitted in the source (source play list), according to a time frame of the receiving of the identifying data. The matcher 1330 may then automatically match the relevant items with at least one content item.

The apparatus also includes a provisioner 1340, for provisioning selected content items to the user.

For example, as a user watches a Soccer Match being broadcast on a TV sport channel, a commercial is played. The user is induced to buy a content item promoted in the commercial. The user sends his request and, and the content item is sold to the user.

The apparatus according to a preferred embodiment further includes a correlation data generator 1350, connected with the provisioner 1340, for generating people meter correlation statistics, as described hereinabove, thus providing a people metering utility. For example, the data generator 1350 may generate statistics indicating a correlation between a commercial broadcast on a certain TV channel and provisioning of a content item promoted in the commercial.

Reference is now made to FIG. 13b which is a block diagram illustrating a second apparatus for people metering according to a preferred embodiment of the present invention.

An apparatus 1302 according to a preferred embodiment of the present invention may include a data receiver 1360 which is used to retrieve a user sent request 1312 for a content item to be provisioned to the user and a provisioner 1370, for provisioning the requested content item to the user.

The apparatus 1302 further comprises a matcher 1380 which is used to match the provisioned content item to relevant items transmitted in a source. The source may be but is not limited to a broadcasting channel such as a TV station or a radio channel, an Internet P2P channel, etc.

Optionally, the matcher 1380 is configured to read the relevant items from one or more list(s), each list comprising items transmitted in a respective source, according to a time frame of the request made by the user.

By this matching, the matcher 1380 uncovers a linkage between the request of the user and a transmitted item that may be the inducer of the request, say a commercial or a show the user watches on a TV channel.

The apparatus 1302 further includes a correlation data generator 1390, for generating people meter correlation statistics, utilizing the above described matching, uncovering a linkage between a specific channel/show/commercial and an impulsive request to purchase the advertised product.

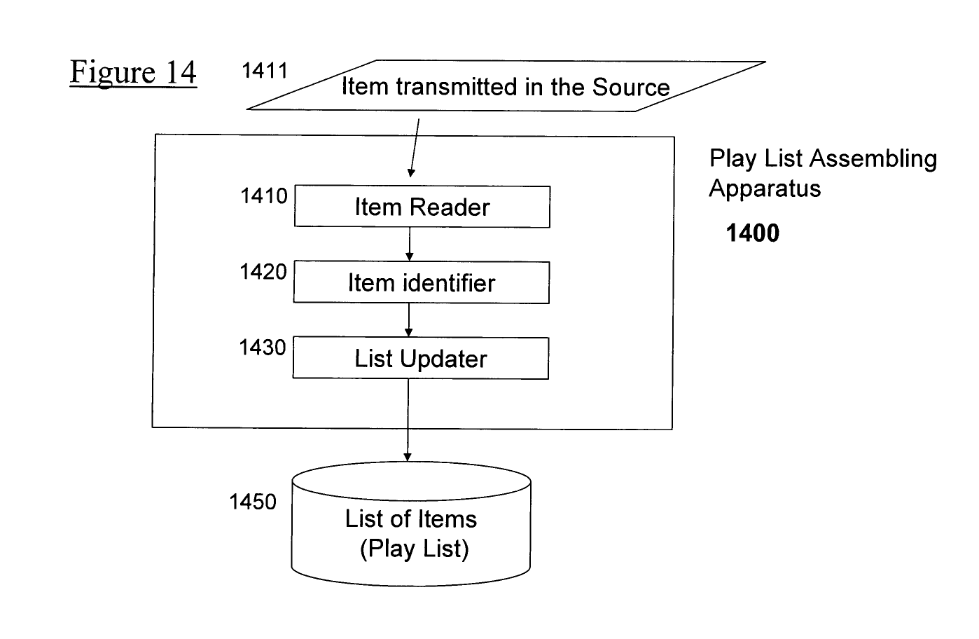

Reference is now made to FIG. 14 which is a block diagram illustrating an apparatus for assembling a source list of items (a channel play list), according to a preferred embodiment of the present invention.

The apparatus 1400 comprises a source item reader 1410, for reading an item being transmitted in the source 1411.

The apparatus 1400 also includes an item identifier 1420, connected to the source item reader 1410.

The item identifier 1420 is configured to identify the read item transmitted in the source. The item identifier 1420 may employ any of the above described methods for identifying the transmitted item. The item identifier 1420 may also employ any other method which is known in the art, for identifying the source transmitted item.

The apparatus 1200 may further comprise a list updater 1430, connected to the item identifier 1420, for adding identifing data of the transmitted item into a source list of items (a channel play list) 1450.

In one example, the apparatus 1400 may be used by a copyright organization such as Israel's Acum (www.acum.org.il) which is a non-profit corporation administering copyrights assigned to its members—authors, composers, lyricists, poets, and music publishers.

With the apparatus 1400, Acum may track the broadcasting of content items on the growing number of broadcasting channels (TV, Radio, Internet radio sites, etc.) for billing the channel operators for broadcasting content items that are owned by Acum members, so as to enable collection of royalties for the members of Acum.

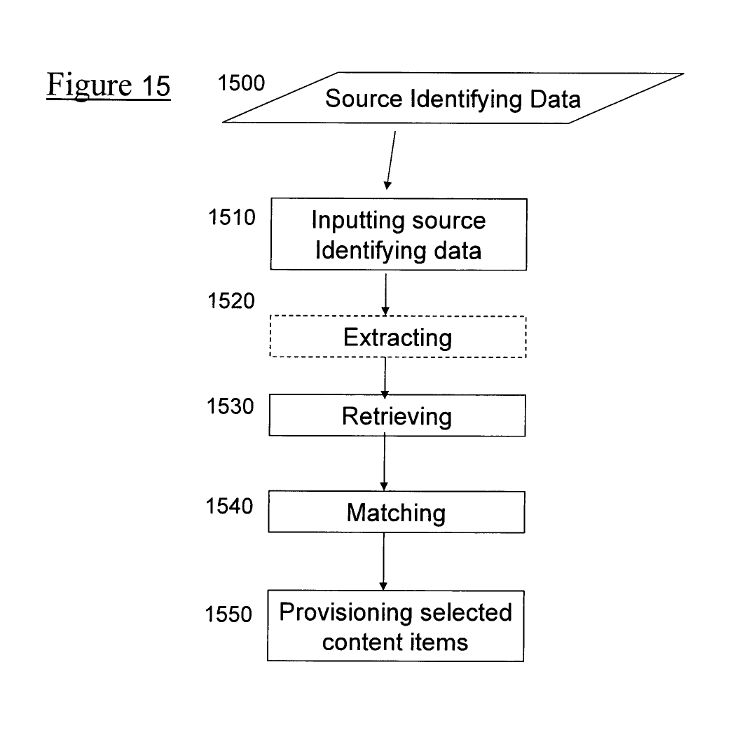

Reference is now made to FIG. 15 which is flow chart illustrating a method for provisioning content in an intuitive-associative manner, according to a preferred embodiment of the present invention.

In a method according to a preferred embodiment of the present invention, source identifying data 1500 is input from a user 1510, say by the above described data receiver 310. The source may be, but is not limited to, a broadcasting channel such as a TV channel or a radio channel, a narrow-casting channel such a video on demand (VOD) channel, an internet channel, a P2P data channel, or any other source.

The source identifying data 1500 may be textual (for example—a SMS textual message like: <MTV>) or non-textual (for example—a snap shot of a show being broadcasted on TV, where a channel logo may be found).

The source identifying data may be processed for extracting a source identifier 1520 from the source identifying data 1500, say by a source extractor 320, as discussed in greater detail hereinabove.

Next relevant items transmitted in the source at a time frame of the user input data are fetched.

In a preferred embodiment, one or more relevant item are retrieved 1530 from an updated list of items transmitted in the source (a play list), according to a time frame of the inputting of the source identifying data 1500. Optionally, the time frame may be extracted from a time stamp associated with the user provided source identifying data.

The relevant items are then matched 1540 with one or more content item(s), as described in greater detail hereinabove.

Finally, one or more of the matched content items are selected and provisioned to the user 1550, as described hereinabove.

For example, a user may watch a clip on MTV, impulsively decide he wants it, though failing to identify the performer or song, send a SMS textual message: <MTV>, and eventually purchase one or more ringtones of songs that are performed by a performer of the clip.

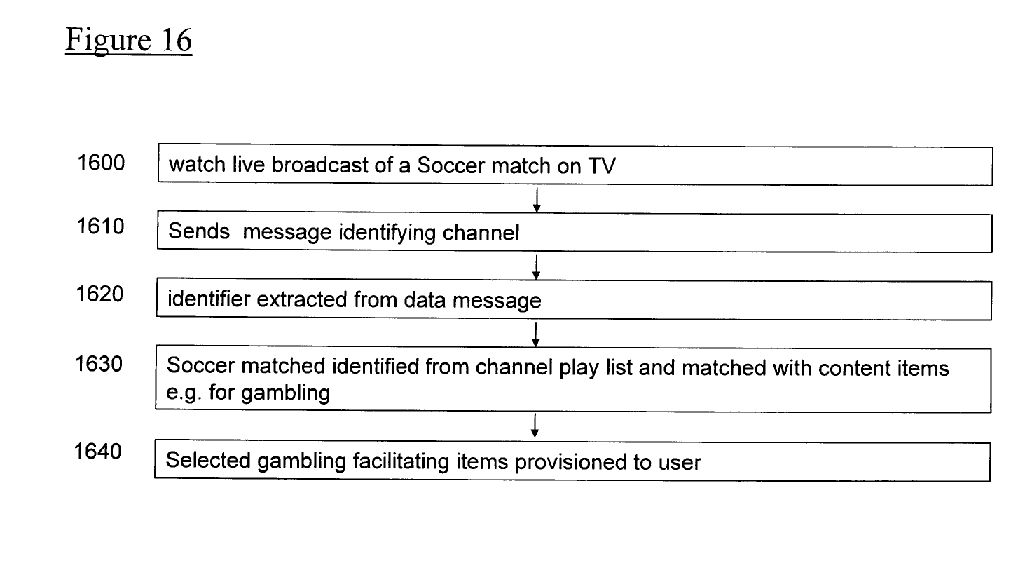

Reference now is made to FIG. 16 which is a flow chart illustrating an exemplary gambling scenario according to a preferred embodiment of the present invention.

For example, a user watches a live broadcast of a Soccer match on a TV source 1600. When a user sent data message 1610 identifying the TV channel is input by the data receiver 310, the source extractor 320 extracts the TV channel identifier from the data message 1620.

The matcher 330 retrieves 1630 the live broadcast match from the list of items transmitted in the channel (the TV channel play list), and matches the live broadcast match with content items facilitating a gambling service such as a link to a web page where the user may make a bet against another user or against the house, the house being an external content provider.

Selected items of the gambling (or betting) content items (for example, web links) are then provisioned to the user 1640, thus facilitating his participation in the gambling.

There are many betting formulas that may be applied in such a scenario: the user may bet on a goal in the next few minutes, the user may bet on the final result of the match, the user may bet on who is going to score in the next few minutes, the user may vote on the most interesting minute in the match (to be determined by the voters), etc.

An apparatus according to a preferred embodiment of the present invention may also be used as a part of an interactive gambling platform. For example, a user may be asked to choose among various gambling schemes relating to a Soccer match he watches, say betting on match results vs. betting on performance of players. If the user chooses to bet on players he may be provided a list of players and bet on the player who scores the next goal, etc.

In another example, an apparatus according to a preferred embodiment of the present invention is used for downloading a computer game just played on a computer game zone TV channel.

In another example the apparatus according to a preferred embodiment of the present invention may facilitate participation in an auction running live on a TV channel, where a participator may send an SMS message when he wishes to buy the product presented in the channel in the currently bid price.

An apparatus according to a preferred embodiment of the present invention may be used for purchasing products as well as services, as described in hereinabove, say for purchasing a Golf club membership upon watching a program about Golf.

An apparatus according to a preferred embodiment of the present invention may also be used to interactively purchase video clips, video data etc. as described in greater detail hereinabove.

An apparatus according to a preferred embodiment of the present invention may also facilitate a scenario where music items played in a local source such as a music system run in a pub, connected to the apparatus, may be provisioned to a pub visitor who sends an SMS identifying the pub whose music system provides the music items.

For example, the assembler described hereinabove may communicate with an agent installed locally at the pub, for receiving the music items, data identifying the music items, or a combination thereof.

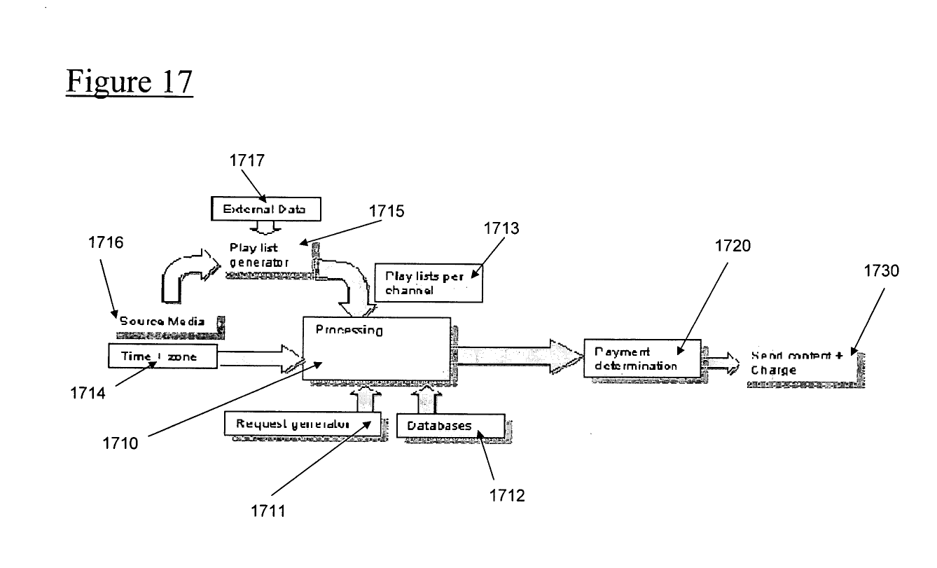

Reference is now made to FIG. 17 which is a flow chart illustrating a billing method according to a preferred embodiment of the present invention.

A billing method according to a preferred embodiment of the present invention is comprised of three main stages: processing a request 1710, payment determination 1720, and finally sending content items to the user and charging for the content items 1730.

As described in greater detail hereinabove, in the processing stage, the user sent source identifying data is used for extracting the source identifier, say using a request generator 1711.

The processing stage further uses database data 1712, as described hereinabove to retrieve relevant items from a source specific play list 1713, according to the time frame when the user sends his request and the geographical zone where from the request is sent 1714.

As described hereinabove, the source specific play list 1713 is assembled by a play list generator (assembler) 1715 which reads the various source media 1716 comprising of the items that are transmitted in the source as well as external data 1717.

The relevant items are matched with content items, say by a matcher 330 as described hereinabove, and one or more of the matched content items are selected for provisioning to the user.

In the payment determination 1720 stage, the billing tasks relating to the provisioned content items are being carried out, say by a billing module as described hereinabove.

Finally, the user is provisioned with the content items and charged for the content items 1730, as determined in the payment determination stage.

The billing module may use billing relevant data such as the user ID, the name of the user, the address of the user, payment means, and charge the user using a variety of payment methods, including but not limited to: using the credit card of the user, using the bank account of the user, a reverse billing SMS where the owner of the recipient phone rather than the sender of the message is charged for the cost of the SMS, etc.

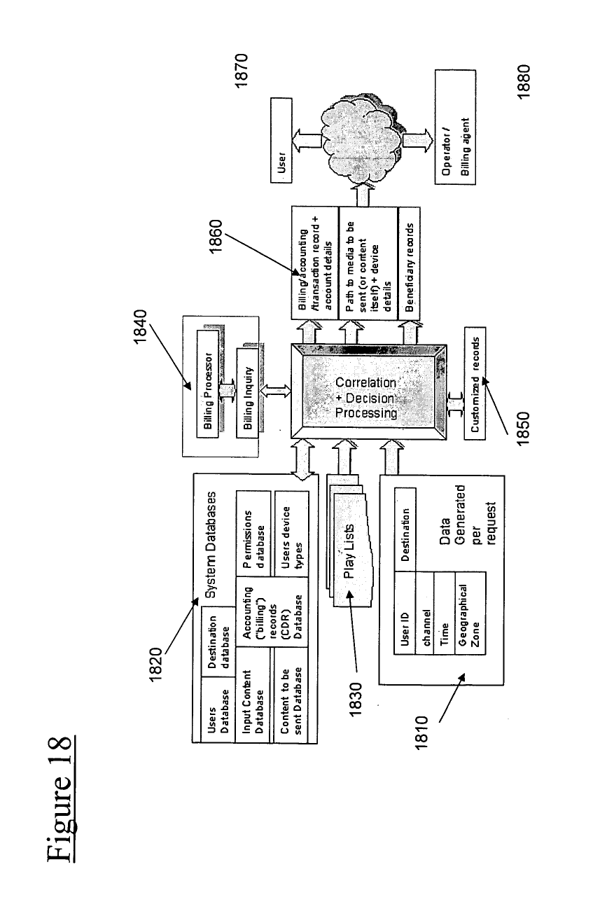

Reference is now made to FIG. 18 which is a detailed flow chart illustrating a billing method according to a preferred embodiment of the present invention.

A billing method according to a preferred embodiment of the present invention includes the following activities:

Receiving a user sent relevant data 1810, including but not limited to: a User ID/details, the source, time of the request (may also be determined at the receiving side), geographical data (For example, if a user input a MTV identifier, it may be possible to determine if the user watches MTV Europe or MTV Asia based on his geographical location), a receiving device type, a payment method (as described hereinabove), etc.

processing the user sent data 1810 utilizing data residing in system databases 1820 and source play lists 1830, as described in greater detail above, for provisioning selected content items to the user.

sending a billing query to the billing processor/module 1840, the billing module 1840 may utilize billing customization records 1850, defining billing rules for the billing module to follow.

generating relevant records for 1860 billing, accounting, provisioning of content items, and paying royalties to copyright holders of the provisioned content items, as described in greater detail hereinabove.

sending the relevant records to the user 1870 and to other sides 1880 which may include but are not limited to: content providers, service operators, billing agents (say, a bank), etc.

Table 1 provides several examples for implementing a method in accordance with preferred embodiment of the present invention.

TABLE 1

| | | | | Package to | |
|---|---|---|---|---|---|
| | | Play list | The system may | be sent, | |
| Source media | | of source | include DB | includes | |
| that triggers the | Request | media, | created and | part of, or | Form of |
| transaction | Generator | Generated by | maintained | at least | payment |
| Radio | Remote control | Automatic | Users | Content | Credit Card |
| | | recognition | (phone numbers, | sold or a | |
| | | | email addresses, | link/path | |
| | | | user names, user | to the | |
| | | | Id, . . . ) | content | |
| TV | Mobile phone | A person | Paying identity + balance | Destination | Field |
| | | | | device | operator |
| PC | Fixed phone | A list given by | Songs, other input | Destination | Mobile |
| | | the media | content | type | operator |
| | | channel | | | |
| | | operator | | | |
| Internet event | SMS | A computer | Content to be sent: | Transaction | Prepaid |
| | | program | ring tones, ring | charge | card |
| | | | back tones, video | | |
| | | | clips, icons, | | |
| | | | games, etc. | | |
| Random selection | Internet | Other Data | Accounting | Beneficiary | In cash |
| | | base | records | | |
| Selection per | PC | Data | Destinations | Transaction | Checks |
| criteria (e.g. | | generated by a | phone numbers, | code | |
| performer) | | third party | Device type | | |
| Printed | WAP session | | | Customized | Other credit |
| Advertisement | | | | records | method |
| Theatre/movie/ | Java program | | | | Other credit |
| live | | | | | method |
| performance/sport | | | | | |
| event or play | | | | | |
| Transmitted | Brew program | | | | Other credit |
| Advertisement | | | | | method |
| | DECT phone | | | | |
| | Other event | | | | |
| Peer to Peer | Mobile device | | | | |

The source transmitting a content item as described hereinabove, may belong to any of the following source types, or to any other source type:
Digital or Analog Terrestrial Radio broadcasting.
Digital or Analog Terrestrial TV broadcasting.
Cable TV broadcasting.
Satellite TV broadcasting.
Satellite radio broadcasting.
Internet radio broadcasting.
Internet video streaming.
Mobile phones video/audio streaming.
Mobile TV broadcasting.
IP based Video and Audio streaming.
Movie in a theatre, or to another limited size audience.
Football arena and other sport play grounds.
Narrowcasting of any audio, video or any other digital content or data.
Service oriented networks such as i-mode.
The user may send the channel identifying data using any known in the art device, including but not limited to:
Mobile phones
PDA
A personal computer
A TV set-top box
A TV remote control
A dedicated music and video players such as i-Pod
A gaming console such as a Sony Play station™ device.
Blackberry and the like.
The identifying data may be sent in any of the following data formats, or at any other data for-mat:
SMS
MMS
E-mail
Picture Message
Picture of any type
Recordable sound
Recordable video text
Proprietary outgoing message by a device client
HTML request
URL (by web or wap)
IVR (such as DTMF)
By voice—directly through IVR or using a dial in service
In an audio format, attached to any of the above formats
By Interactive TV methods
Using Barcode
By handwriting
The channel transmitted item may belong to any one of the following types, or to any other type:
Song tracks
Song clips
TV shows
Sport games
Radio programs
News bulletins
Any other video/audio/picture item.
The content items that may be provisioned to the user may include but are not limited to the following types:
Ringtones for mobile phones, (e.g. monophonic, polyphonic, “true tone”/wave based/MP3/other audio, picture and video based)
Ringback tones for mobile phones
Audio digital tracks in all file types such as (but not limited to) MP3, ACC, WAV etc.
Video digital clips in any known in the art media types such as (but not limited to) MPEG, MPG, RM, AVI, WMV, MOV etc.
Digital pictures in known in the art media types such as (but not limited to) JPG, JPEG, Gif, BMP
Mobile phone icons in various formats
Mobile phone wallpapers
Mobile phone MMS clips and other video clips
PC Games
Console games
Internet downloadable games
Mobile phone games
Multi-player games
Associated information in various formats such as video, audio and text
Associated links in various formats such as Web links and WAP links
URLs
Text Documents (such as recipes, articles, gossips)
Digital books
Audio books
Movies
Coupons
One time passwords
Other passwords
Links to any of the above or below
Full or snipped content from the broadcasted media itself
Recommendations for additional content based on preferences or provisioning history of the user
Albums, movies, Cd roms, audio discs, video discs, content reviews, tickets for a movie, etc.
Links to media-related chat rooms,
Links to shared music lists.
The selected provisioned content item(s) may be received by the user, utilizing a receiving device, including but not limited to:
Mobile phones
PDA
Personal computers
TV set-top boxes
Dedicated Music and Video players such as iPod
Gaming consoles
Instant messenger—such as AIM (ICQ)™, Yahoo™, Microsoft™, etc.
Skype™ clients or similar IP telephony/video service clients
The provisioned content item(s) may be delivered to the user through any of the following and other methods, or a combination thereof:
E-mails (with or without attachments)
SMS
MMS
WAP links
URLS
Web links
Podcasting (downloading of audio broadcasts to iPod™) and the like
Media device client session (such as Java sessions)
FTP
Direct download
Download via a device client

Automatic Crawlers and Database Management Tools

A preferred embodiment of the present invention may employ any of the following crawlers and database management tools:

a tool which feeds a content catalog builder with new content items upon the updating of an existing content database with a new content item.

a tool which automatically feeds a content catalog builder with any new content item that is automatically generated by a content generator as described hereinabove.

a tool which merges content items/indexes database records received from a content provider into a content catalog and/or a content database.

a tool which synchronizes local databases with affiliate content provider or any other relevant business partner databases.

a tool which synchronizes multiple subsets of any of the databases described in the application, utilizing a full copy or a change based update mechanism.

a dedicated tool may be used to automatically extract content transmitted in a channel, split it, categorize it (music/talks/commercial/show/etc.) and index it using a local or an external database. Optionally, the categorization carried out by the dedicated tool may serve as the basis for a policy defining how a transmitted item 5 belonging to a certain category is treated by a system according to a preferred embodiment of the present invention. For example—it may be defined that transmitted advertisement items are not added by the assembler to a play list, a user may be paid a coupon for listening to a certain advertisement item on a certain channel (thereby enabling to identify target audience for advertised services), it may be defined that an advertisement item is added by the assembler to a play list but only as the clip played in the advertisement item, an advertisement item may be added to a play list for provisioning the product or service it promotes through a web site(as described hereinabove), etc.

a dedicated tool may be used to extract identification data of a transmitted item using radio display system (RDS), or from the transmitted item itself.

a crawler may be connected to any public, internal, external, or other database for detecting new content and forwarding add it to a content catalog, using the content catalog builder as described above.

a tool which handles the synchronization of databases that are internal or external to the apparatus 3000.

Marketing Techniques

In a preferred embodiment the apparatus 3000 may be used to implement a marketing technique, such as the following:

Multi level marketing—the user may be motivated, say by promising the user a commission, to forward advertisement links or any other provisioned content items to other users.

Word of link—promotional links that may be inserted into GUI pages sent to the user, insertion of promotional ringtones into GUI pages sent to the user

Cross marketing—insertion of services that are associatively linked with the content items that are presented to the user via the GUI pages.

White labeling—the apparatus 3000 may be used by another service, and the operators of the other service may inform their users that the other service is facilitated using the technology provided by the apparatus, thus exposing the service provided by the apparatus 3000 to new potential users.

Off line promotions—such as using a radio broadcast to publish the service. For example—send a SMS message to a specific number and receive a just played ringtone.

It is expected that during the life of this patent many relevant devices and systems will be developed and the scope of the terms herein, particularly of the terms “Internet”, “Cellular phone”, “PDA”, “Palm pilot” “SMS”, “Channel”, “Broadcasting”, “Narrowcasting”, “Content”, “Ringtone”, “Monotone”, “Polytone”, “Clip”, and “GUI”, is intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for provisioning content in an intuitive-associative manner, comprising: a data receiver, for receiving data identifying a transmission source from a user;
a matcher, associated with said data receiver, for matching at least one relevant item transmitted in the source at a time frame of said receiving with at least one content item; and
a provisioner, associated with said matcher, for provisioning selected content items of said content items to the user.

2. The apparatus of claim 1, wherein said data receiver is further configured to communicate with a client agent installed on a remote unit, for receiving said data identifying said transmission source, said client agent being configured to extract said data identifying said transmission source from a sample taken from said transmission source.

3. The apparatus of claim 2, wherein said sample is a snapshot taken from said transmission source.

4. The apparatus of claim 2, wherein said remote unit is a cellular phone.

5. The apparatus of claim 2, wherein said remote unit is a computer.

6. The apparatus of claim 1, further comprising an extractor, associated with said data receiver, for extracting an identity of said source from said data.

7. The apparatus of claim 1, wherein said source is a broadcasting channel.

8. The apparatus of claim 1, wherein said source is a narrowcasting channel.

9. The apparatus of claim 1, wherein said source is a peer-to-peer channel.

10. The apparatus of claim 1, wherein said data further comprises a preference parameter, indicating a preference of a user, and said provisioner is further configured to choose said selected content items according to said preference parameter.

11. The apparatus of claim 1, wherein said matcher is further configured to retrieve said relevant items from a list of items transmitted in the source.

12. The apparatus of claim 11, further comprising an assembler, for dynamically assembling said list of items transmitted in the source over said time frame.

13. The apparatus of claim 12, wherein said assembler is further configured to communicate with a client agent installed on a remote unit, for receiving data identifying said items transmitted in the source at said time frame.

14. The apparatus of claim 12, wherein said assembler comprises:
a source item reader, for reading an item being transmitted in said source;
an item identifier, associated with said source item reader, for generating data identifying said transmitted item; and
a list updater, associated with said item identifier, for updating said list of items with said data identifying said transmitted item and a respective time frame of transmission of said identified transmitted item.

15. The apparatus of claim 14, wherein said item identifier is further configured to compare a fingerprint extracted from said read item with at least one identifying fingerprint residing in a content catalog, each of said identifying fingerprints relating to a respective content item.

16. The apparatus of claim 14, wherein said item identifier is further operable by a user for providing said data identifying said transmitted item.

17. The apparatus of claim 14, wherein said item identifier is further configured to standardize said data identifying said transmitted item.

18. The apparatus of claim 14, wherein said item identifier is further configured to textually standardize said data identifying said transmitted item.

19. The apparatus of claim 14, wherein said item identifier is further configured to use data pertaining to a location of a fingerprint within an item, for carrying out said identifying.

20. The apparatus of claim 12, wherein said assembler further comprises a statistics generator, configured to dynamically generate statistics relating to items transmitted in said source.

21. The apparatus of claim 14, wherein said item identifier is further configured to use one of a group comprising: statistics relating to items transmitted in said source, general statistics relating to transmitted items, and statistics relating to preferences according to a geographic region of said source.

22. The apparatus of claim 1, further comprising a content catalog builder, for building a content catalog, said content catalog builder comprising:
an item receiver, for receiving a content item,
an identification receiver, for receiving identification data of said content item,
a fingerprint extractor, for extracting an identifying fingerprint from said content item, and
a content updater, for updating the content catalog with said identifying fingerprint and with said identification data.

23. The apparatus of claim 22, wherein said identification receiver is further operable by a user for providing said identification data.

24. The apparatus of claim 22, wherein said identification receiver is further configured to standardize said identification data.

25. The apparatus of claim 22, wherein said identification receiver is further configured to textually standardize said data identifying said transmitted item.

26. The apparatus of claim 22, wherein said content catalog builder further includes a remote content updater, operable for remotely updating the content catalog with an identifying fingerprint pointing to a remotely stored content item.

27. The apparatus of claim 22, wherein said content catalog builder further includes a remote content updater, operable for remotely updating the content catalog with identification data relating to a remotely stored content item.

28. The apparatus of claim 22, wherein said content updater is further configured to update the content catalog with data pertaining to a location of said fingerprint within said content item.

29. The apparatus of claim 1, wherein said provisioner is further configured to present said content items to said user in a dynamically configurable interactive graphical user interface (GUI).

30. The apparatus of claim 1 wherein said provisioner is further configured to present said content items to said user by a multi paged graphical interaction with said user.

31. The apparatus of claim 1, wherein said provisioner is further configured to select at least one of said content items for provisioning to said user, according to at least one of a group comprised of: a predefined preference with respect to said content items, information relating to the user, information relating to content items, provisioning history data, capabilities of a receiving device used by said user, geographic data, demographic data, socio-economical data, and user made selections.

32. The apparatus of claim 1, wherein said data comprises non-textual data.

33. The apparatus of claim 6, wherein said extractor is configured to utilize at least one of a group comprising: optical character recognition (OCR), image processing, and spelling correction.

34. The apparatus of claim 1, further comprising a content generator, for generating a new content item from an existing content item.

35. The apparatus of claim 1, further comprising a history recorder, associated with said provisioner, configured to record history data relating to content provisioning to said user.

36. The apparatus of claim 35, wherein said history recorder is further configured to record back-up data pertaining to said provisioned content items, for future use by said user.

37. The apparatus of claim 1, further comprising a format converter, associated with said provisioner, configured to convert a content item into a format usable by a receiving device used by said user.

38. The apparatus of claim 1, further comprising a correlation data generator, associated with said provisioner, configured to generate correlation data pertaining to correlation between transmission of an item in a source and provisioning of a respective content item to a user.

39. The apparatus of claim 38, wherein said correlation data comprises at least one of a group comprising: user characterizing data, source data, time of provisioning, type of content item, geographic data, demographic data, and socio-economic data.

40. The apparatus of claim 1 wherein said selected content items of said content items are provisioned to the user as web links.

41. Method for provisioning content in an intuitive-associative manner, comprising:
receiving data identifying a transmission source from a user;
matching at least one relevant item transmitted in the source at a time frame of said receiving with at least one content item; and
provisioning selected content items of said content items to the user.

42. The method of claim 41, further comprising extracting an identity of said source from said data.

43. The method of claim 41, wherein said matching includes retrieving said relevant items from a list of items transmitted in the source.

44. The method of claim 43, further comprising dynamically assembling said list of items, said assembling comprising:
reading an item being transmitted in said source,
identifying said transmitted item, and
adding identification data of said identified transmitted item and a respective time frame of transmission of said identified transmitted item to said list of items.

45. The method of claim 44, wherein said identifying further includes a comparison of a fingerprint extracted from said read item with at least one identifying fingerprint residing in a content catalog, each of said identifying fingerprints relating to a respective content item.

46. The method of claim 45, wherein said comparison further includes using data pertaining to a location of a fingerprint within an item.

47. The method of claim 44, further comprising dynamically generating statistics relating to items transmitted in said source.

48. The method of claim 44, wherein said identifying is carried out using one of a group comprising: statistics relating to items transmitted in said source, general statistics relating to transmitted items, and statistics relating to preferences according to a geographic region of said source.

49. The method of claim 41, further comprising updating a content catalog, said updating comprising:
receiving a content item,
receiving identification data of said content item,
extracting an identifying fingerprint from said content item, and
updating said content catalog with said identifying fingerprint and with said identification data.

50. The method of claim 49, further comprising updating said content catalog with data pertaining to a location of said fingerprint within said content item.

51. The method of claim 41, wherein said provisioning further includes presenting said content items to said user in a dynamically configurable interactive graphical user interface (GUI).

52. The method of claim 41, wherein said provisioning comprises a multi paged graphical interaction with said user.

53. The method of claim 41, wherein said provisioning comprises selecting at least one of said content items for provisioning to said user, according to at least one of a group comprised of: a predefined preference with respect to said content items, information relating to said user, information relating to content items, provisioning history data, capabilities of a receiving device used by said user, geographic data, demographic data, socio-economical data, and user made selections.

54. The method of claim 41, wherein said data comprises non-textual data.

55. The method of claim 42, wherein said extracting an identifier of said source from the identifying data is carried out utilizing at least one of a group comprising: optical character recognition (OCR), image processing, and spelling correction.

56. The method of claim 41, further comprising generating a new content item from an existing content item.

57. The method of claim 41, further comprising recording history data relating to content provisioning to said user.

58. The method of claim 41, further comprising recording back-up data pertaining to said selected content items, for future use by said user.

59. The method of claim 41, wherein said provisioning further comprises converting a content item into a format usable by a receiving device used by said user.

60. The method of claim 41, further comprising generating correlation data pertaining to correlation between transmission of an item in a source and provisioning of a respective content item to a user.

61. The method of claim 60, wherein said correlation data further includes at least one of a group comprising: user characterizing data, source data, time of provisioning, type of content item, geographic data, demographic data, and socio-economic data.

62. The method of claim 41, wherein said selected items of said content items are provisioned to the user as web links.

63. Apparatus for provisioning content in an intuitive-associative manner, comprising:
a data receiver, for receiving a user message;
a provisioner, associated with said data receiver, for provisioning a content item to a user, according to said user message;
a matcher, associated with said provisioner, for matching said provisioned content item with a relevant item from at least one item transmitted in a respective source, said matching being carried out according to a time frame of said user message and relevance of said transmitted item to said provisioned content item; and
a correlation data generator, associated with said matcher, for generating data pertaining to correlation between said relevant item and said provisioned item.

64. The apparatus of claim 63, wherein said matcher is further configured to retrieve said relevant item from a list of items transmitted in said source.

65. The apparatus of claim 1, wherein said provisioner is further configured to facilitate gambling, utilizing said selected content items.

66. Apparatus for assembling a source list of items, comprising:
a source item reader, for reading an item being transmitted in the source;
an item identifier, associated with said source item reader, for identifying said transmitted item; and
a list updater, associated with said item identifier, for updating the source list of items with identification data of said identified transmitted item and a respective time frame of transmission of said identified transmitted item.

67. The apparatus of claim 66, wherein said item identifier is further configured to compare a fingerprint of said read item with at least one identifying fingerprint residing in a content catalog, each of said identifying fingerprints relating to a respective content item.

68. The apparatus of claim 66, wherein said item identifier is further configured to use data pertaining to a location of a fingerprint within an item, for carrying out said identifying.

69. The apparatus of claim 66, further comprising a statistics generator, configured to dynamically generate statistics relating to items transmitted in the source.

70. The apparatus of claim 66, wherein said item identifier carries out said identifying using one of a group comprising: statistics relating to items transmitted in the source, general statistics relating to transmitted items, and statistics relating to preferences according to a geographic region of the source.

71. Apparatus for provisioning content in an intuitive-associative manner, comprising: a data receiver, for receiving data identifying a transmission source from a user;
a matcher, associated with said data receiver, for matching at least one relevant item transmitted in the source with at least one content item; and
a provisioner, associated with said matcher, for provisioning selected content items of said content items to the user.
